(19) United States
(12) Patent Application Publication
(10) Pub. No.: US 2026/0370436 A1
(43) Pub. Date: Nov. 19, 2026

(54) ENHANCED TRANSMISSION CONFIGURATION INDICATOR (TCI) STATE ACTIVATION FOR DUAL TRANSMISSION RECEPTION POINT (TRP) OPERATION

(71) Applicant: QUALCOMM Incorporated, San Diego, CA (US)

(72) Inventors: Kiran VENUGOPAL, Green Brook, NJ (US); Yan ZHOU, San Diego, CA (US)

(21) Appl. No.: 19/208,076

(22) Filed: May 14, 2025

(51) Int. Cl. H04L 5/00; H04W 72/21; H04W 72/231; H04W 72/232

(52) U.S. Cl. CPC H04L 5/0098; H04W 72/21; H04W 72/231; H04W 72/232

(57) ABSTRACT

This disclosure provides methods, components, devices and systems for enhanced transmission configuration indicator (TCI) state activation for dual transmission reception point (TRP) operation. For example, a user equipment (UE) may receive control signaling indicating a first set of TCI states configured for a first TRP and a second set of TCI states configured for a second TRP. The UE may receive one or more medium access control-control elements (MAC-CE) that activate one or more first TCI states of the first set of TCI states and activate one or more second TCI states of the second set of TCI states. The UE may communicate with the first TRP using at least one TCI state of the one or more first TCI states and communicate with the second TRP using at least one TCI state of the one or more second TCI states in accordance with the one or more MAC-CEs.

### TECHNICAL FIELD

This disclosure relates generally to wireless communication, and more specifically to systems, devices, methods, and techniques associated with enhanced transmission configuration indicator (TCI) state activation for dual transmission reception point (TRP) operation.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving control signaling indicating a first set of transmission configuration indicator (TCI) states configured for a first transmission reception point (TRP) and a second set of TCI states configured for a second TRP, where the UE performs downlink communications with the first TRP, and where the UE performs uplink communications with the second TRP, receiving a medium access control-control element (MAC-CE) that activates one or more first TCI states of the first set of TCI states and activates one or more second TCI states of the second set of TCI states, communicating with the first TRP using at least one TCI state of the one or more first TCI states in accordance with the MAC-CE, and communicating with the second TRP using at least one TCI state of the one or more second TCI states based on the MAC-CE.

A UE for wireless communications is described. The UE may include a processing system that includes processor circuitry and memory circuitry that stores code. The processing system may be configured to cause the UE to receive control signaling indicating a first set of TCI states configured for a first TRP and a second set of TCI states configured for a second TRP, where the UE performs downlink communications with the first TRP, and where the UE performs uplink communications with the second TRP, receive a MAC-CE that activates one or more first TCI states of the first set of TCI states and activates one or more second TCI states of the second set of TCI states, communicate with the first TRP using at least one TCI state of the one or more first TCI states in accordance with the MAC-CE, and communicate with the second TRP using at least one TCI state of the one or more second TCI states based on the MAC-CE.

Another UE for wireless communications is described. The UE may include means for receiving control signaling indicating a first set of TCI states configured for a first TRP and a second set of TCI states configured for a second TRP, where the UE performs downlink communications with the first TRP, and where the UE performs uplink communications with the second TRP, means for receiving a MAC-CE that activates one or more first TCI states of the first set of TCI states and activates one or more second TCI states of the second set of TCI states, means for communicating with the first TRP using at least one TCI state of the one or more first TCI states in accordance with the MAC-CE, and means for communicating with the second TRP using at least one TCI state of the one or more second TCI states based on the MAC-CE.

A non-transitory computer-readable medium storing code for wireless communications is described. The code may include instructions executable by one or more processors to receive control signaling indicating a first set of TCI states configured for a first TRP and a second set of TCI states configured for a second TRP, where the UE performs downlink communications with the first TRP, and where the UE performs uplink communications with the second TRP, receive a MAC-CE that activates one or more first TCI states of the first set of TCI states and activates one or more second TCI states of the second set of TCI states, communicate with the first TRP using at least one TCI state of the one or more first TCI states in accordance with the MAC-CE, and communicate with the second TRP using at least one TCI state of the one or more second TCI states based on the MAC-CE.

In some examples of the method, UEs, and non-transitory computer-readable medium described herein, the method, apparatuses, and non-transitory computer-readable medium may include further operations, features, means, or instructions for activating, via the MAC-CE, a first set of codepoints that correspond to the first set of TCI states and a second set of codepoints that correspond to the second set of TCI states.

Some examples of the method, UEs, and non-transitory computer-readable medium described herein may further include operations, features, means, or instructions for receiving first DCI that indicates a first codepoint of the first set of codepoints in accordance with a first bit of the first DCI having a first bit value, where the first codepoint indicates the at least one TCI state of the one or more first TCI states.

Some examples of the method, UEs, and non-transitory computer-readable medium described herein may further include operations, features, means, or instructions for receiving second DCI that indicates a second codepoint of the second set of codepoints in accordance with a first bit of the second DCI having a second bit value that may be different from the first bit value, where the second codepoint indicates the one or more second TCI states.

In some examples of the method, UEs, and non-transitory computer-readable medium described herein, the MAC-CE includes a first set of bit fields, each bit field of the first set of bit fields corresponding to a respective codepoint of the first set of codepoints, the MAC-CE includes a second set of bit fields, each bit field of the second set of bit fields corresponds to a respective codepoint of the second set of codepoints, a first value of a bit field of the first set of bit fields or the second set of bit fields indicates that a corresponding codepoint indicates an uplink TCI state and a downlink TCI state, and a second value of the bit field indicates that the corresponding codepoint indicates a downlink TCI state, a joint TCI state, or an uplink TCI state.

In some examples of the method, UEs, and non-transitory computer-readable medium described herein, the method, apparatuses, and non-transitory computer-readable medium may include further operations, features, means, or instructions for activating, via the MAC-CE, a set of codepoints that correspond to both the first set of TCI states and the second set of TCI states, where each codepoint of the set of codepoints corresponds to one of the first set of TCI states, one of the second set of TCI states, or both in accordance with a first set of bit fields of the MAC-CE, a second set of bit fields of the MAC-CE, or both.

A method for wireless communications by a UE is described. The method may include receiving control signaling indicating a first set of TCI states configured for a first TRP and a second set of TCI states configured for a second TRP, where the UE performs downlink communications with the first TRP, and where the UE performs uplink communications with the second TRP, receiving a first MAC-CE that activates a first set of codepoints that correspond to the first set of TCI states in accordance with a first bit of the MAC-CE having a first value, receiving a second MAC-CE that activates a second set of codepoints that correspond to the second set of TCI states in accordance with a first bit of the second MAC-CE having a second value that is different from the first value, communicating with the first TRP using one or more first TCI states of the first set of TCI states in accordance with the first MAC-CE, and communicating with the second TRP using one or more second TCI states of the second set of TCI states in accordance with the second MAC-CE.

A UE for wireless communications is described. The UE may include a processing system that includes processor circuitry and memory circuitry that stores code. The processing system may be configured to cause the UE to receive control signaling indicating a first set of TCI states configured for a first TRP and a second set of TCI states configured for a second TRP, where the UE performs downlink communications with the first TRP, and where the UE performs uplink communications with the second TRP, receive a first MAC-CE that activates a first set of codepoints that correspond to the first set of TCI states in accordance with a first bit of the MAC-CE having a first value, receive a second MAC-CE that activates a second set of codepoints that correspond to the second set of TCI states in accordance with a first bit of the second MAC-CE having a second value that is different from the first value, communicate with the first TRP using one or more first TCI states of the first set of TCI states in accordance with the first MAC-CE, and communicate with the second TRP using one or more second TCI states of the second set of TCI states in accordance with the second MAC-CE.

Another UE for wireless communications is described. The UE may include means for receiving control signaling indicating a first set of TCI states configured for a first TRP and a second set of TCI states configured for a second TRP, where the UE performs downlink communications with the first TRP, and where the UE performs uplink communications with the second TRP, means for receiving a first MAC-CE that activates a first set of codepoints that correspond to the first set of TCI states in accordance with a first bit of the MAC-CE having a first value, means for receiving a second MAC-CE that activates a second set of codepoints that correspond to the second set of TCI states in accordance with a first bit of the second MAC-CE having a second value that is different from the first value, means for communicating with the first TRP using one or more first TCI states of the first set of TCI states in accordance with the first MAC-CE, and means for communicating with the second TRP using one or more second TCI states of the second set of TCI states in accordance with the second MAC-CE.

A non-transitory computer-readable medium storing code for wireless communications is described. The code may include instructions executable by one or more processors to receive control signaling indicating a first set of TCI states configured for a TRP and a second set of TCI states configured for a second TRP, where the UE performs downlink communications with the first TRP, and where the UE performs uplink communications with the second TRP, receive a first MAC-CE that activates a first set of codepoints that correspond to the first set of TCI states in accordance with a first bit of the MAC-CE having a first value, receive a second MAC-CE that activates a second set of codepoints that correspond to the second set of TCI states in accordance with a first bit of the second MAC-CE having a second value that is different from the first value, communicate with the first TRP using one or more first TCI states of the first set of TCI states in accordance with the first MAC-CE, and communicate with the second TRP using one or more second TCI states of the second set of TCI states in accordance with the second MAC-CE.

### BRIEF DESCRIPTION OF THE DRAWINGS

FIG. 1 shows an example of a wireless communication system.

FIG. 2 shows an example of a signaling diagram that supports enhanced transmission configuration indicator (TCI) state activation for dual transmission reception point (TRP) operation.

FIG. 3 shows an example of a medium access control-control element (MAC-CE) format that supports enhanced TCI state activation for dual TRP operation.

FIG. 4 shows an example of a MAC-CE format that supports enhanced TCI state activation for dual TRP operation.

FIG. 5 shows an example of a MAC-CE format that supports enhanced TCI state activation for dual TRP operation.

FIG. 6 shows an example of a MAC-CE format that supports enhanced TCI state activation for dual TRP operation.

FIG. 7 shows an example of a process flow that supports enhanced TCI state activation for dual TRP operation.

FIG. 8 shows an example of a process flow that supports enhanced TCI state activation for dual TRP operation.

FIG. 9 shows a block diagram of a processing system that supports enhanced TCI state activation for dual TRP operation.

FIG. 10 shows a diagram of a system including a device that supports enhanced TCI state activation for dual TRP operation.

FIGS. 11 and 12 show flowcharts illustrating methods that support enhanced TCI state activation for dual TRP operation.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be formatted to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may support decoupled downlink and uplink cell operation, in which a user equipment (UE) may communicate with different transmission reception points (TRPs) in the downlink communication direction and the uplink communication direction, resulting in improved communication throughput. In such cases, to facilitate communications with the two TRPs, the UE may receive a configuration for each TRP, where each configuration may indicate a respective set of transmission configuration indicator (TCI) states. In some other systems, to activate a TCI state for a single TRP, the UE may receive a medium access control-control element (MAC-CE) that activates a set of codepoints corresponding to a set of TCI states configured for the single TRP. For example, each codepoint of the set of codepoints may indicate one or more TCI states from the set of TCI states configured for the single TRP. As such, when the UE receives an indication of a codepoint of the set of codepoints, the UE may know which TCI states of the set of TCI states to use for communications with the single TRP. However, utilizing such MAC-CEs formatted to activate one or more TCI states for a single TRP may be insufficient to activate respective TCI states for two TRPs. For example, such MAC-CEs may not indicate to which set of TCI states the activated TCI states belong. As such, how to interpret the activation of the one or more TCI states for one or more TRPs may be ambiguous to the UE.

Accordingly, aspects of the subject matter described in this disclosure relate to MAC-CE formats and rules that enable a UE to be activated with TCI states for both TRPs via one or more MAC-CEs. For example, the UE may receive control signaling indicating the first set of TCI states configured for the first TRP and the second set of TCI states configured for the second TRP, where the first set of TCI states are associated with the downlink communication direction and the second set of TCI states is associated with the uplink communication direction. In some examples, the UE may receive a single MAC-CE that activates one or more TCI states included in the first set of TCI states and the second set of TCI states, where the MAC-CE further indicates which set of TCI states each activated TCI state belongs to. In some other examples, the UE may receive a first MAC-CE that activates one or more first TCI states included in the first set of TCI states and a second MAC-CE that activates one or more second TCI states included in the second set of TCI states, where each of the first MAC-CE and the second MAC-CE further indicate which set of TCI states each activated TCI state belongs to. In this way, the UE may be activated with one or more TCI states for both TRPs via one or more MAC-CEs.

Particular aspects of the subject matter described in this disclosure can be implemented to realize one or more of the following potential advantages. In some examples, by indicating which set of TCI states the one or more activated TCI states belong to, the described techniques can be used to reduce signaling overhead associated with decoupled downlink-uplink cell operations and improve communication efficiency and reliability.

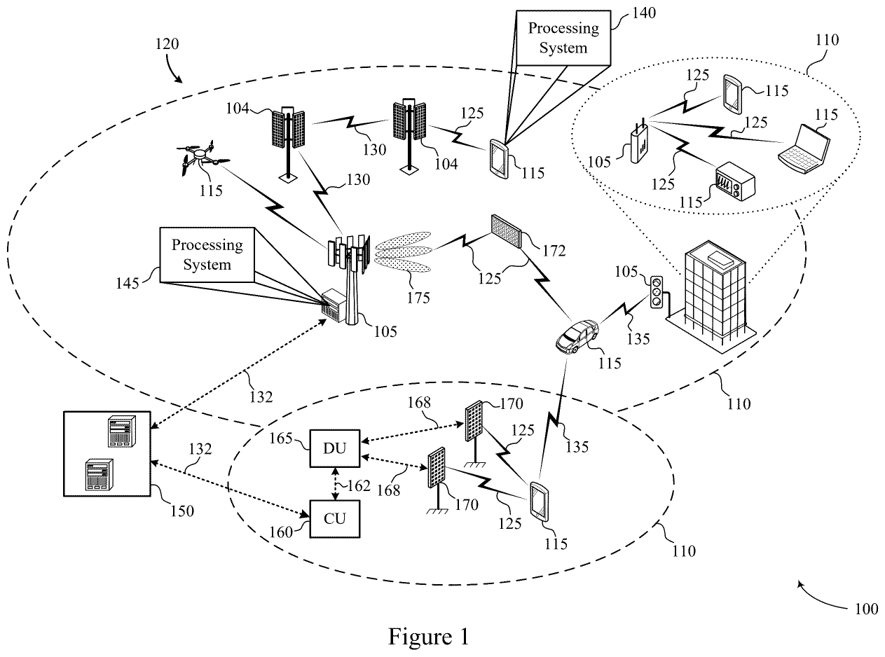

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for enhanced TCI state activation for dual TRP operation. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support efficient and accurate decoupled downlink-uplink cell switch.

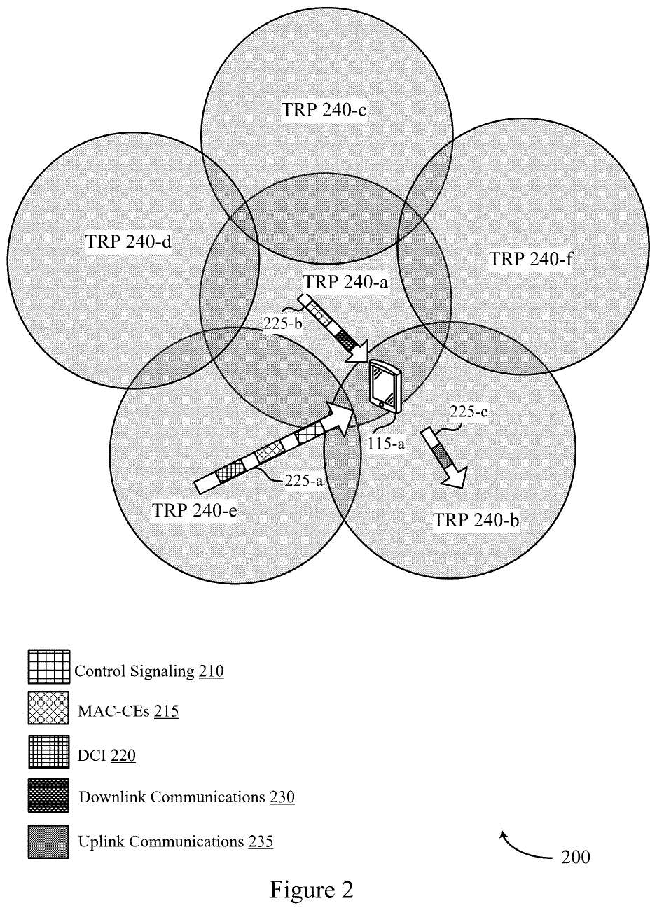

FIG. 2 shows an example of a signaling diagram 200 that supports enhanced TCI state activation for dual TRP operation. The signaling diagram 200 may implement, or be implemented by, aspects of the wireless communication system 100, as described herein and in accordance with the techniques described herein with reference to FIG. 1. For example, the signaling diagram 200 may include a set of TRPs 240 and a UE 115-a, which may represent examples of a UE 115, or some other devices, as described herein with reference to FIG. 1. A source TRP 240-e may communicate with the UE 115-a via a downlink communication link 225-a, a first TRP 240-a may communicate with the UE 115-a via a second downlink communication link 225-b, and a second TRP 240-b may communicate with the UE 115-a via a third communication link 225-c.

The techniques described in the context of the signaling diagram 200 enable the source TRP 240-e (e.g., prior to the cell switch), a TRP 240-a (e.g., after the cell switch), or both to transmit MAC-CE(s) 215 that activate one or more first TCI states from a first set of TCI states configured for the first TRP 240-a and one or more second TCI states from a second set of TCI states configured for a second TRP 240-b. The MAC-CE 215 further indicates, for each activated TCI state, whether the activated TCI state belongs to the first TCI set of TCI states configured for the first TRP 240-a or the second set of TCI states configured for the second TRP 240-b. The UE 115-a may communicate downlink communications 230 with the first TRP 240-a using a first TCI state activated from the first set of TCI states, and may communicate uplink communications 235 with the second TRP 240-b using a second TCI state activated from the second set of TCI states.

In some wireless communication systems, the UE 115-a may receive a MAC-CE that indicates a control resource set (CORESET) pool identifier (ID) via a CORESET pool ID field and activates up to 8 codepoints (e.g., TCI codepoints) for a serving cell associated with the CORESET pool ID. For example, the MAC-CE may include a set of bit fields where the value of each bit field of the set of bit fields indicates whether a codepoint corresponding to the bit field indicates a downlink TCI state, an uplink TCI state, a joint TCI state, or any combination thereof from a set of TCI states identified by the CORESET pool ID. The value of one or more D/U bits included in the MAC-CE specify whether a corresponding codepoint indicates a downlink TCI state and a joint TCI state (e.g., D/U equals 1) or whether the corresponding codepoint indicates an uplink TCI state (e.g., D/U equals 0). In some other cases, the UE 115-a may receive a MAC-CE that activates up to 8 sets of codepoints for a serving cell based on a TCI state type ID (e.g., unified TCI state type ID) specifying joint or separate TCI state activation. For example, the MAC-CE may include one or more sets of bit fields where each bit field of the one or more sets of bit fields has a value that indicates whether a codepoint corresponding to the bit field indicates a TCI state included in a set of TCI states configured for the serving cell, an uplink TCI state included in the set of TCI states configured for the serving cell, a downlink TCI state included in the set of TCI states configured for the serving cell, or any combination thereof. As such, the UE 115-a may receive a MAC-CE that activate one or more TCI states for a single TRP 240.

Some wireless communication systems may support decoupled downlink-uplink cell operation, where the UE 115-a may communicate with the first TRP 240-a in the downlink communication direction and communicate with the second TRP 240-b in the uplink communication direction, which may increase communication throughput. For example, in some cases, the source TRP 240-e or the UE 115-a may select a single target candidate configuration associated with a single TRP to be used for both downlink communications and uplink communications in response to a triggering event (e.g., downlink reference signal received power (RSRP) based cell report). The target candidate configuration associated with the single TRP may provide improved throughput in one communication direction (e.g., the downlink communication direction) but not the other communication direction (e.g., the uplink communication direction) in cases where downlink-uplink asymmetry (e.g., asymmetry in terms of transmission power, coverage, signal to interference and noise ratio (SINR), throughput, or any combination thereof) is present. As such, when decoupled downlink-uplink cell operation is supported, the source TRP 240-e or the UE 115-a may select candidate configurations associated with different TRPs (e.g., any of TRP 240-a, TRP 240-b, TRP 240-c, TRP 240-d, TRP 240-f) from the set of TRPs to be used for downlink communications and uplink communication respectively. For example, the source TRP 240-e or the UE 115-a may evaluate a set of candidate configurations corresponding to a set of TRPs in both the downlink direction and the uplink direction and may select, based on a corresponding downlink metric and a corresponding uplink metric, the first TRP 240-a for downlink communications and the second TRP 240-b for uplink communications. In such cases, decoupled downlink-uplink cell operation may achieve performance gains in both the uplink and downlink communication directions.

In such cases, the UE 115-a may receive a MAC-CE (e.g., a decoupled downlink-uplink cell switch command MAC-CE) that indicates configurations for two different TRPs to be used for downlink communications and uplink communications respectively. For example, the MAC-CE may indicate the first TRP 240-a for downlink communications and the second TRP 240-b uplink communications by including an ID of a candidate configuration for the first TRP 240-a and an ID of a candidate configuration for the second TRP 240-b. Each of the first TRP 240-a and the second TRP 240-b and its respective candidate configuration is associated with a physical cell site ID (e.g., TRP 0, TRP 1 . . . TRP 6) and one or more component carrier configurations.

For example, in the case decoupled downlink-uplink cell operation without component carrier aggregation, each respective candidate configuration is associated with a single component carrier configuration. In such cases, when two different TRPs are selected for decoupled downlink-uplink cell operation, a serving cell (e.g., serving cell ID) for the UE 115-a is formed dynamically by the candidate configurations (e.g., candidate configuration IDs) associated with the two different TRPs. In the case of decoupled downlink-uplink cell operation with component carrier aggregation, each respective candidate configuration may be associated with multiple component carrier configurations (e.g., 8 or more). In such cases, the serving cell for the UE 115-a is formed by up to two component carrier configurations from each respective candidate configuration, where a quantity of candidate serving cells is formed by the different combinations of the component carrier configurations associated with each respective candidate configuration, and where each candidate serving cell is identified by a logical serving cell ID. As such, the MAC-CE may indicate that the serving cell is associated with two TRPs and identified by a single logical serving cell ID.

However, the MAC-CE may not clearly indicate how the UE 115-a is to interpret TCI state activation when two different candidate configurations corresponding to two different TRPs are indicated to the UE 115-a. For example, each candidate configuration may be associated with a set of TCI states including a quantity of downlink TCI or joint TCI states and a quantity of uplink TCI states (e.g., up to 128 downlink or joint TCI states and 64 uplink TCI states) and up to 8 candidate configurations may be configured (e.g., based on UE capability). As such, the MAC-CE may activate one or more TCI states from each set of TCI states associated with the indicated candidate configurations, however the MAC-CE may not indicate to the UE 115-a which set of TCI states the one or more activated TCI states belong to.

Accordingly, aspects of the subject matter described in this disclosure relate to MAC-CE formats and rules that indicate to the UE 115-a which respective set of TCI states one or more activated TCI states are associated with. For example, the UE 115-a may receive control signaling 210 (e.g., RRC signaling, including candidate configurations for each TRP 240, a MAC-CE cell switch command indicating the IDs of the candidate configurations) indicating the first set of TCI states configured for the first TRP 240-a and the second set of TCI states configured for the second TRP 240-b, where the first set of TCI states is associated with the downlink communication direction and the second set of TCI states is associated with the uplink communication direction. The UE 115-a may receive the MAC-CE 215 that activates one or more TCI states included in the first set of TCI states and one or more TCI states included in the second set of TCI states, where the MAC-CE 215 further indicates which set of TCI states each activated TCI state belongs to. Thus, the UE 115-a may apply a TCI state from the first set of TCI states for downlink communications with the first TRP 240-a and may apply a TCI state from the second set of TCI states for uplink communications with the second TRP 240-b.

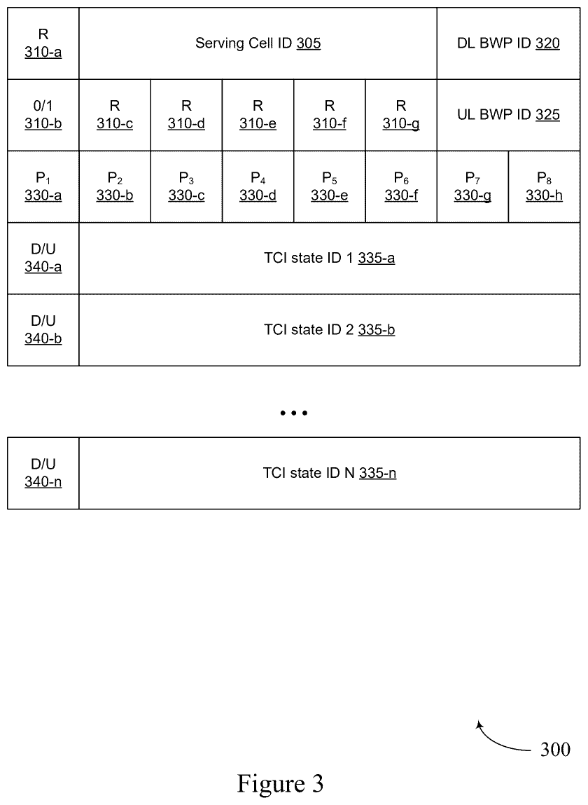

In some cases, as described in further detail with reference to FIG. 3, the UE 115-a may receive two separate MAC-CEs 215 that each activate a respective set of codepoints that correspond to the first set of TCI states configured for the first TRP 240-a and the second set of TCI states configured for the second TRP 240-b. The two separate MAC-CEs 215 may each include a bit (e.g., a reserved bit), where the value of the bit indicates which set of TCI states the respective set of codepoints belongs to. For example, the UE 115-a may receive a first MAC-CE, where the value of the bit included in the first MAC-CE equals 0. Based on the value of the bit being 0, the UE 115-aknows that a first set of codepoints activated by the first MAC-CE are associated with the first set of TCI states configured for the first TRP 240-a. The UE 115-a may additionally receive a second MAC-CE, where the value of the bit included in the second MAC-CE equals 1. Based on the value of the bit being 1, the UE 115-a knows that the second set of codepoints activated by the second MAC-CE are associated with the second set of TCI states configured for the second TRP. Thus, the first MAC-CE and the second MAC-CE indicate to the UE 115-a, via the value of the bit, which set of TCI states the activated sets of codepoints belong to.

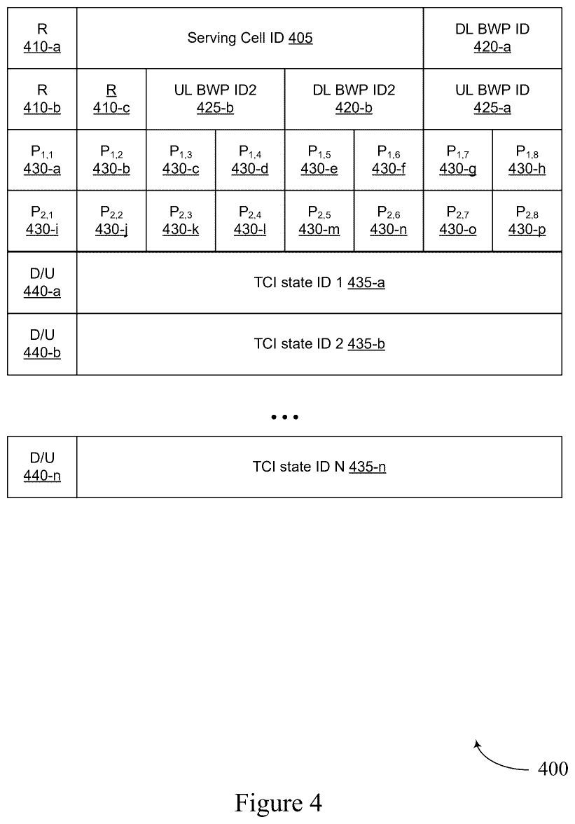

In some other cases, as described in further detail with reference to FIG. 4, the UE 115-a may receive a single MAC-CE 215 that activates both a first set of codepoints that corresponds to the first set of TCI states configured for the first TRP 240-a and a second set of codepoints that corresponds to the second set of TCI states configured for the second TRP 240-b. For example, the UE 115-a may receive the MAC-CE 215 that includes a first set of bit fields corresponding to the first set of codepoints and a second set of bit fields corresponding to the second set of codepoints. Each bit included in the first set of bit fields and each bit included in the second set of bit fields has a value that indicates whether a codepoint corresponding to the bit field indicates an uplink TCI state, a downlink TCI state, a joint TCI state, or a combination thereof included in either the first set of TCI states or the second set of TCI states. As such, the MAC-CE 215 may activate one or more TCI states from the first set of TCI states and one or more TCI states from the second set of TCI states and may indicate to the UE 115-a which set of TCI states each activated TCI state belongs to.

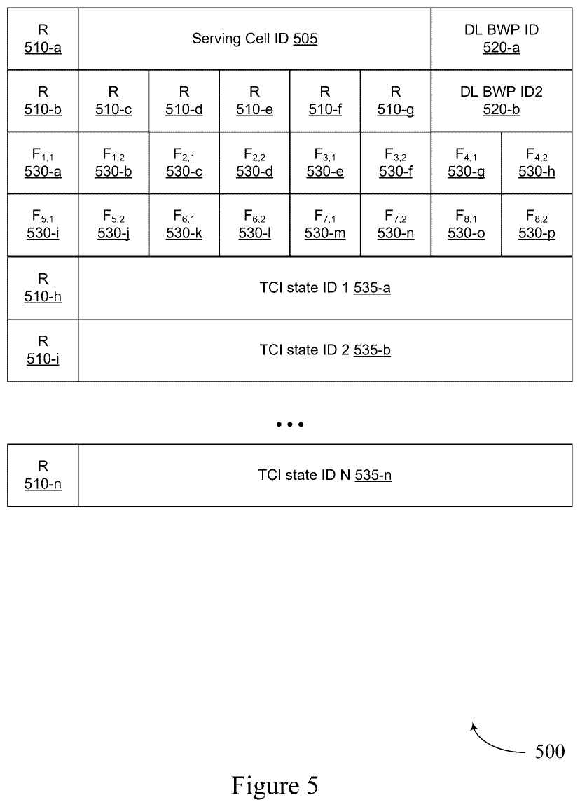

Additionally, in some other cases, as described in further detail with reference to FIG. 5, the UE may receive a single MAC-CE 215 that may activate a set of codepoints that corresponds to both the first set of TCI states configured for the first TRP 240-a and the second set of TCI states configured for the second TRP 240-b. For example, the MAC-CE 215 may include a first subset of bit fields of the set of bit fields that corresponds to the first set of TCI states, and a second subset of bit fields of the set of bit fields that corresponds to the second set of TCI states. The value of each bit field included within the first subset of bit fields indicates whether a codepoint corresponding to the bit field indicates a TCI state included in the first set of TCI states, while the value of each bit field included in the second subset of bit fields indicates whether a codepoint corresponding to the bit field indicates a TCI state included in the second set of TCI states. Each codepoint may correspond to a bit field included in the first subset of bit fields and a bit field included in the second subset of bit fields such that the codepoint may indicate a TCI state included in either the first set of TCI states or the second set of TCI states, or both the first set of TCI states and the second set of TCI states. As such, the MAC-CE 215 may activate one or more TCI states from the first set of TCI states and one or more TCI states from the second set of TCI states and may indicate to the UE 115-a which set of TCI states each activated TCI state belongs to.

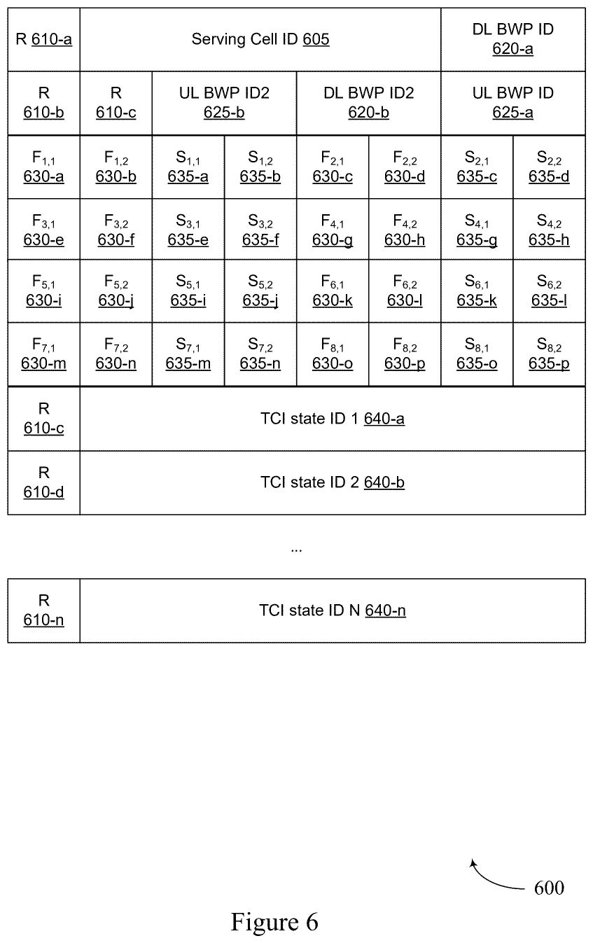

Further, in some other cases, as described in further detail with reference to FIG. 6, the MAC-CE 215 may activate a set of codepoints that corresponds to both the first set of TCI states configured for the first TRP 240-a and the second set of TCI states configured for the second TRP 240-b. For example, the MAC-CE 215 may include first set of bit fields that corresponds to downlink TCI states included in the first set of TCI states and the second set of TCI states, and a second set of bit fields that corresponds to uplink TCI states included in the first set of TCI states and the second set of TCI states. Additionally, a first subset of bit fields of the first set of bitfields corresponds to downlink TCI states of the first set of TCI states, while a second subset of bit fields of the first set of bit fields corresponds to downlink TCI states included in the second set of TCI states. As such, a value of each bit field included in the first set of bit fields indicates whether a codepoint corresponding to the bit field indicates a one or more downlink TCI states of the first set of TCI states, one or more downlink TCI states of the second set of TCI states, or both. Additionally, a first subset of bit fields of the second set of bit fields corresponds to uplink TCI states of the first set of TCI states, while a second subset of bit fields of the second set of bit fields corresponds to uplink TCI states included in the second set of TCI states. As such, a value of each bit field included in the second set of bit fields indicates whether a codepoint corresponding to the bit field indicates a one or more uplink TCI states of the first set of TCI states, one or more uplink TCI states of the second set of TCI states, or both. As such, the MAC-CE 215 may activate one or more TCI states from the first set of TCI states and one or more TCI states from the second set of TCI states and may indicate to the UE 115-a which set of TCI states each activated TCI state belongs to.

In some cases, the UE 115-a may receive DCI 220 that indicates one or more codepoints included in a set of codepoints indicated by the MAC-CE 215, where the one or more codepoints indicate one or more TCI states to be used by the UE 115-a for communications with the first TRP 240-a and the second TRP 240-b. For example, the UE 115-a may receive a first DCI where the value of a bit included in the first DCI indicates whether a codepoint indicated by the first DCI belongs to the first set of TCI states or the second set of TCI states. For example, if the value of the bit included in the first DCI equals 0, then the UE 115-a knows that the first DCI indicates a codepoint that indicates one or more TCI states included in the first set of TCI states. If the value of the bit included in the first DCI equals 1, then the UE 115-a knows that the first DCI indicates a codepoint that indicates one or more TCI states included in the second set of TCI states. The UE 115-a may additionally receive second DCI that indicates a second codepoint that indicates one or more TCI states of the first set of TCI states or one or more TCI states of the second set of TCI states based at least in part on the first DCI. For example, if the first DCI indicates a codepoint that indicates a one or more TCI states of the first set of TCI states, the second DCI may indicate a codepoint that indicates one or more TCI states of the second set of TCI states. As such, based on receiving the control signaling 210, the MAC-CE 215, and the DCI 220, the UE 115-a may communicate with the first TRP 240-a and the second TRP 240-b using a first TCI state of the first set of TCI states and a second TCI of the second set of TCI states, respectively.

In some cases, the MAC-CE 215 may indicate a single TRP to be used for both the downlink communications 230 and the uplink communication 235. For example, the MAC-CE 215 may include an ID (e.g., an extended logical channel ID field (eLCID) within a sub header) that indicates that the MAC-CE 215 activates TCI states from the first set of TCI states. As such, the value of one or more bit fields included in a set of bit fields of the MAC-CE 215 that do not correspond to the first set of TCI states (e.g., bit fields correspond to the second set of TCI states) may be set to 0. Additionally, one or more BWP IDs fields that correspond to the second TRP 240-b included in the MAC-CE 215 may be set to 0. As such, the MAC-CE 215 may indicate that the first TRP 240-a is to be used for both the downlink communications 230 and the uplink communications 235 by setting one or more bit fields corresponding to the second TRP 240-b to 0.

FIG. 3 shows an example of a MAC-CE format 300 that supports enhanced TCI state activation for dual TRP operation. The MAC-CE format 300 (e.g., unified TCI framework) may implement, or be implemented by, aspects of the wireless communication system 100, the signaling diagram 200, or both. For example, a UE, a source TRP, a first TRP, and a second TRP, which may be examples of the corresponding device as described herein with reference to FIGS. 1 and 2, may perform TCI state activation in accordance with the MAC-CE format 300.

As described herein with reference to FIG. 2, to perform a decoupled downlink-uplink cell switch operation, a UE may receive control signaling (e.g., RRC signaling, cell switch command MAC-CE, among other examples) that indicates a first set of TCI states configured for a first TRP (e.g., having a first candidate configuration ID) and a second set of TCI states configured for a second TRP (e.g., having a second candidate configuration ID). The first TRP may be selected (e.g., by the UE, by a node of the network, by a source TRP) for downlink communications, while the second TRP may be selected for uplink communications. To facilitate such communication, and in accordance with the techniques described herein with reference to FIG. 3, the UE may receive two separate MAC-CEs, formatted according to the MAC-CE format 300, that activate respective subsets of TCI states included in the first set of TCI states and the second set of TCI states, such that the UE may perform the decoupled cell-switch operation and communicate with the first and second TRPs, respectively. As an illustrative example, the UE may receive a first MAC-CE, formatted according to the MAC-CE format 300, which activates a first subset of TCI states from the first set of TCI states. The UE may also receive a second MAC-CE, formatted according to the MAC-CE format 300, which activates a first subset of TCI states from the second set of TCI states.

To do so, the MAC-CE format 300 may include multiple bit fields, such as a Serving Cell ID 305 of the serving cell formed by both the first and second TRP, a set of codepoints 335 (e.g., specifying TCI state IDs, such as a codepoint 335-a, 335-b, through 335-n), a BWP ID 320 (e.g., DL BWP ID 320), a BWP ID 325 (e.g., UL BWP ID 325), one or more D/U fields 340 (e.g., D/U fields 340-a, 340-b, through 340-n), a set of bit fields 330 (e.g., Pᵢ, bit fields 330-a, 330-b, 330-c, 330-d, 330-e, 330-f, 330-g, and 330-h), and a set of reserved bits 310 (e.g., formatted as R, reserved bits 310-a, 310-c, 310-d, 310-e, 310-f, and 310-g). In some examples, to differentiate between activation of the first set of TCI states for the first TRP and the second set of TCI states for the second TRP, the MAC-CE format 300 may include a first bit 310-b that indicates whether the associated MAC-CE activates TCI states from the first set of TCI states or TCI states from the second set of TCI states. That is, the MAC-CE format 300 may utilize the first bit 310-b to indicate which selected TRP of the decoupled uplink-downlink cell operation the TCI state ID (codepoint 335) points to.

In such examples, if the UE receives a MAC-CE, formatted according to the MAC-CE format 300, where the value of the first bit 310-b included in the MAC-CE equals 0, then the UE 115 knows (e.g., has an indication) that the MAC-CE activates or deactivates TCI states that corresponds to the first candidate configuration ID indicated in the decoupled downlink-uplink cell switch command MAC-CE. That is, if the UE receives a MAC-CE with the first bit 310-b equal to 0, the UE may have an indication that the MAC-CE activates or deactivates TCI states included in the first set of TCI states configured for the first TRP.

Alternatively, if the UE receives a MAC-CE, formatted according to the MAC-CE format 300, where the value of the first bit 310-b included in the MAC-CE equals 1, then the UE 115 knows (e.g., has an indication) that the MAC-CE activates or deactivates TCI states that corresponds to the second candidate configuration ID indicated in the decoupled downlink-uplink cell switch command MAC-CE. That is, if the UE receives a MAC-CE with the first bit 310-b equal to 1, the UE may have an indication that the MAC-CE activates or deactivates TCI states included in the second set of TCI states configured for the second TRP.

In such examples, to activate and deactivate the TCI states, the UE may identify a bit value of each bit field 330, where each bit field 330 corresponds to a respective codepoint 335. For example, bit field 330-a may correspond to codepoint 335-a, while bit field 330-b may correspond to codepoint 335-b, and so on. Each bit field 330 of the set of bit fields 330 may indicate whether a codepoint 335 has a downlink TCI state and an uplink TCI state, or has a downlink TCI state and/or a joint TCI state or an uplink TCI state only. For example, if Pᵢ=1, then codepoint i has a single downlink TCI state and a single uplink TCI state, otherwise, if Pᵢ=0, then codepoint i includes only the downlink and/or joint TCI state or the uplink TCI state.

Because the UE may receive two separate MAC-CEs for activation of respective subsets of TCI states for the first TRP and the second TRP, the UE may receive two separate DCIs to indicate the TCI states of the respective subsets of TCI states, where the DCI indicating the TCI codepoint may carry an additional bit to specify which set of TCI states the TCI codepoint belongs. For example, if the UE receives a DCI that includes an additional bit having a value of 0, then the UE has an indication that the one or more codepoints 335 indicated via that DCI correspond to the first candidate configuration ID (e.g., the first TRP). Alternatively, if the UE receives a DCI that includes an additional bit having a bit value of 1, then the UE has an indication that the one or more codepoints 335 indicated via that DCI correspond to the second candidate configuration ID (e.g., the second TRP).

As an illustrative example of using the MAC-CE format 300, the UE may receive a first MAC-CE that is formatted according to the MAC-CE format 300. The UE may identify that the first bit 310-b has a value of 0, and therefore have an indication that the first MAC-CE may activate and/or deactivate TCI states of the first set of TCI states (e.g., corresponding to the first TRP). Accordingly, if the bit field 330-a has a first bit value (e.g., P₁ equals 1), the UE may have an indication that the first codepoint 335-a is activated and points to a downlink TCI state and an uplink TCI state included in the first set of TCI states configured for the first TRP. In other cases, if the bit field 330-a has a second bit value (e.g., P₁ equals 0), the UE may have an indication that the first codepoint 335-a points to a downlink and/or joint TCI state or an uplink TCI state included in the first set of TCI states configured for the first TRP. Each remaining bit field 330 (e.g., 330-b, 330-d, and so on) included in the first MAC-CE may similarly indicate the status of the corresponding codepoint 335.

Similarly, the UE may also receive a second MAC-CE that is formatted according to the MAC-CE format 300. The UE may identify that the first bit 310-b has a value of 1, and therefore have an indication that the second MAC-CE may activate and/or deactivate TCI states of the second set of TCI states (e.g., corresponding to the second TRP). Accordingly, if the bit field 330-a has a first bit value (e.g., P₁ equals 1), the UE may have an indication that the codepoint 335-a is activated and points to a downlink TCI state and an uplink TCI state included in the second set of TCI states configured for the second TRP. In other cases, if the bit field 330-a has a second bit value (e.g., P₁ equals 0), the UE may have an indication that the codepoint 335-a points to a downlink and/or joint TCI state or an uplink TCI state included in the second set of TCI states configured for the second TRP. Each remaining bit field 330 (e.g., 330-b, 330-d, and so on) included in the second MAC-CE may similarly indicate the status of the corresponding codepoint 335.

Accordingly, the UE may receive a first DCI that indicates one or more codepoints 335, where a value of the additional bit included in the first DCI equals 0. As such, the UE may know (e.g., have an indication) that the one or more codepoints 335 indicated by the first DCI points to a corresponding first TCI state included in the first set of TCI states. Similarly, the UE may receive a second DCI that indicates one or more codepoints 335, where a value of the additional bit included in the second DCI equals 1. As such, the UE may know (e.g., have an indication) that the one or more codepoints 335 indicated by the second DCI points to corresponding TCI states included in the second set of TCI states. In this way, the UE may communicate in the downlink direction with the first TRP using the TCI states indicated by the first DCI and may communicate with the second TRP in the uplink direction using the TCI states indicated by the second DCI.

In some examples, if the UE receives a cell switch MAC-CE that indicates a single TRP, the UE may receive a single MAC-CE, formatted according to the MAC-CE format 300, where the first bit 310-b is set to 0.

FIG. 4 shows an example of a MAC-CE format 400 that supports enhanced TCI state activation for dual TRP operation. The MAC-CE format 400 (e.g., unified TCI format) may implement, or be implemented by, aspects of the wireless communication system 100, the signaling diagram 200, or both. For example, a UE, a source TRP, a first TRP, and a second TRP, which may be examples of the corresponding device as described herein with reference to FIGS. 1 and 2, may perform enhanced TCI state activation in accordance with the MAC-CE format 400 (e.g., an enhanced unified TCI based format)

As described herein with reference to FIG. 2, to perform a decoupled downlink-uplink cell switch operation, the UE may receive control signaling (e.g., RRC signaling, cell switch command MAC-CE, among other examples) that indicates a first set of TCI states (e.g., TCI state pool 1) configured for a first TRP and a second set of TCI states (e.g., TCI state pool 2) configured for a second TRP. The first TRP may be selected (e.g., by the UE, by the source TRP) for downlink communications while the second TRP may be selected for uplink. To facilitate such communications, and in accordance with the techniques described herein with reference to FIG. 4, the UE may receive a MAC-CE, formatted according to the MAC-CE format 400, that activates TCI states included in both the first set of TCI states and the second set of TCI states, such that the UE may perform the decoupled cell-switch operation and communicate with the first TRP and the second TRP, respectively.

To do so, the MAC-CE format 400 may include multiple bit fields, such as a Serving Cell ID 405 of the serving cell formed by both the first and second TRP, a set of codepoints 435 (e.g., one or more sets specifying TCI state IDs of the first set of TCI states and/or the second set of TCI states, the codepoints 435-a, 435-b, through 435-n), a downlink part ID 420-a that is associated with the first TRP, a downlink BWP ID 420-bthat is associated with the second TRP, an uplink BWP ID 425-a that is associated with the first TRP, an uplink BWP ID 425-b that is associated with the second TRP, a first set of bit fields 430 (e.g., P_{1,j}, or bit fields 430-a, 430-b, 430-c, 430-d, 430-e, 430-f, 430-g, and 430-h), a second set of bit fields 430 (e.g., P_{2,j}, or bit fields 430-i, 430-j, 430-k, 430-l, 430-m, 430-n, 430-o, and 430-p), a set of reserved bits 410 (e.g., formatted as R, the reserved bits 410-a, 410-b, and 410-c), and/or one or more D/U fields 440 (e.g., D/U fields 440-a, 440-b, through 440-n).

In such examples, to enable TCI activation and/or deactivation for TCI states from the first and second set of TCI states (e.g., TCI pools) via a single MAC-CE, up to eight TCI codepoints 435 may be specified per TRP using the single MAC-CE. As such, the threshold quantity of codepoints 435 included in a MAC-CE formatted according to the MAC-CE format may be equal to 16.

Each bit field 430 of the first set of bit fields 430 may correspond to a first set of codepoints (e.g., up to 8 TCI codepoints 435) that activate the first set of TCI states and each bit field 430 of the second set of bit fields 430 may correspond to a second set of codepoints (e.g., up to 8 TCI codepoints) that activate the second set of TCI states.

The UE may identify a value of each bit field 430 of the first set of bit fields 430 and a value of each bit field 430 of the second set of bit fields 430, which may indicate whether a codepoint 435 has a downlink TCI state and an uplink TCI state, or has a downlink TCI state and/or a joint TCI state or an uplink TCI state only. For example, if P_{i,j}=1, then codepoint j from TCI state pool i has a single downlink TCI state and a single uplink TCI state, otherwise, if P_{i,j}=0, then codepoint j from TCI state pool i has includes only the downlink and/or joint TCI state or the uplink TCI state.

The UE may receive one or more DCIs that indicate the TCI states of the respective sets of TCI states, where the DCI indicating the TCI codepoint may carry an additional bit to specify which set of TCI states the TCI codepoint belongs. For example, if the UE receives a first DCI that includes an additional bit having a value of 0, then the UE has an indication that the one or more codepoints 435 indicated via that DCI correspond to the first candidate configuration ID (e.g., the first TRP). Alternatively, if the UE receives the first DCI that includes an additional bit having a bit value of 1, then the UE has an indication that the one or more codepoints 435 indicated via that DCI correspond to the second candidate configuration ID (e.g., the second TRP). Based on the value of the additional bit included in the first DCI, the UE may receive a second DCI that includes an additional bit having a value different from the value of the additional bit included in the first DCI.

As an illustrative example of using the MAC-CE format 400, the UE may receive a MAC-CE that is formatted according to the MAC-CE format 400. If the bit field 430-a has a first bit value (e.g., P_{1,1} equals 1), the UE may have an indication that the first codepoint 435-a is activated and points to a downlink TCI state and an uplink TCI state included in the first set of TCI states configured for the first TRP. In other cases, if the bit field 430-a has a second bit value (e.g., P_{1,1} equals 0), the UE may have an indication that the first codepoint 435-a points to a downlink and/or joint TCI state or an uplink TCI state included in the first set of TCI states configured for the first TRP. Each remaining bit field 430 of the first set of bit fields (e.g., 430-b, 430-d, and so on through 430-h) included in the first MAC-CE may similarly indicate the status of the corresponding codepoint 435, which may activate TCI states included in the first set of TCI states configured for the first TRP.

Similarly, if the bit field 430-i has a first bit value (e.g., P_{2,1} equals 1), the UE may have an indication that a second codepoint 435-i corresponding to the bit field 430-i is activated and points to a downlink TCI state and an uplink TCI state included in the second set of TCI states configured for the second TRP. In other cases, if the bit field 430-i has a second bit value (e.g., P_{2,1} equals 0), the UE may have an indication that the first codepoint 435-i points to a downlink and/or joint TCI state or an uplink TCI state included in the second set of TCI states configured for the second TRP. Each remaining bit field 430 of the first set of bit fields (e.g., 430-i, 430-j, and so on through 430-p) included in the first MAC-CE may similarly indicate the status of the corresponding codepoint 435, which may activate TCI states included in the second set of TCI states configured for the second TRP.

In some other examples, if the quantity of codepoints 435 included in the MAC-CE is equal to 8, each codepoint 435 may correspond to both the first set of TCI states and the second set of TCI states. As an illustrative example, if the quantity of codepoints 435 included in the MAC-CE is equal to 8, the UE may identify that the bit field 430-a has a first bit value (e.g., P_{1,1} equals 1) and also identify that the bit field 430-i has a second bit value (e.g., P_{2,1} equals 0). Thus, the UE may have an indication that the codepoint 435-a corresponds to a single downlink TCI state and single uplink TCI state from the first set of TCI states for the first TRP, while the codepoint 435-a also corresponds to a downlink and/or joint TCI state or uplink TCI state from the second set of TCI states for the second TRP. In this way, each codepoint 435 may point to respective TCI states from both the first and second set of TCI states.

Accordingly, the UE may receive a first DCI that indicates one or more codepoints 435, where a value of the additional bit included in the first DCI equals 0. As such, the UE may know (e.g., have an indication) that the one or more codepoints 435 indicated by the first DCI points to a corresponding first TCI state included in the first set of TCI states. Similarly, the UE may receive a second DCI that indicates one or more codepoints 435, where a value of the additional bit included in the second DCI equals 1. As such, the UE may know (e.g., have an indication) that the one or more codepoints 435 indicated by the second DCI points to corresponding TCI states included in the second set of TCI states. In this way, the UE may communicate in the downlink direction with the first TRP using the at least one downlink TCI state indicated by the first DCI and may communicate with the second TRP in the uplink direction using at least one uplink TCI state indicated by the second DCI.

In some examples, if the UE receives a cell switch MAC-CE that indicates a single TRP for both uplink and downlink communications, the UE may receive a MAC-CE, formatted according to the MAC-CE format 400, where the bit fields 430-i through 430-p may be set to 0 (e.g., P_{i,j}=0, for i=2). Additionally, the downlink BWP ID 420-b and/or uplink BWP ID 425-b may be set to 0.

FIG. 5 shows an example of a MAC-CE format 500 that supports enhanced TCI state activation for dual TRP operation. The MAC-CE format 500 (e.g., enhanced unified joint TCI format) may implement, or be implemented by, aspects of the wireless communication system 100, the signaling diagram 200, or both. For example, a UE, a source TRP, a first TRP, and a second TRP, which may be examples of the corresponding device as described herein with reference to FIGS. 1 and 2, may perform enhanced TCI state activation in accordance with the MAC-CE format 500 (e.g., an enhanced unified joint TCI based format).

As described herein with reference to FIG. 2, to perform a decoupled downlink-uplink cell switch operation, a UE may receive control signaling (e.g., RRC signaling, cell switch command MAC-CE, among other examples) that indicates a first set of TCI states configured for a first TRP (e.g., having a first candidate configuration ID corresponding to TCI state pool 1) and a second set of TCI states configured for a second TRP (e.g., having a second candidate configuration ID corresponding to TCI state pool 2). The first TRP may be selected (e.g., by the UE, by a node of the network, by a source TRP) for downlink communications, while the second TRP may be selected for uplink communications. To facilitate such communications, and in accordance with the techniques described herein with reference to FIG. 5, the UE may receive a MAC-CE, formatted according to the MAC-CE format 500, that activates TCI states included in both first set of TCI states and the second set of TCI states, such that the UE may perform the decoupled cell-switch operation and communicate with the first and second TRPs, respectively.

To do so, the MAC-CE format 500 may include multiple bit fields, including a Serving Cell ID 505 of the serving cell formed by both the first and second TRP, a set of codepoints 535 (e.g., specifying TCI state IDs, codepoints 535-a, 535-b, through 535-n), a downlink BWP ID 520-a of the first TRP, a downlink BWP ID 520-b of the second TRP, a set of bit fields 530 (e.g., Fᵢ, ⱼ, bit fields 530-a, 530-b, 530-c, 530-d, 530-e, 530-f, 530-g, 530-h, 530-i, 530-j, 530-k, 530-l, 530-m, 530-n, 530-o, and 530-p), and a set of reserved bits 510 (e.g., formatted as R, reserved bits 510-a, 510-b, 510-c, 510-d, 510-e, 510-f, 510-g, 510-h, 510-i through 510-n).

In such examples, a first subset of bit fields 530 (e.g., F_{i,1}) of the set of bit fields 530 may correspond to the first set of TCI states configured for the first TRP and a second subset of bit fields 530 (e.g., F_{i,2}) of the set of bit fields 530 may correspond to the second set of TCI states configured for the second TRP. Each bit field 530 of the first subset of bit fields 530 and each bit field of the second subset of bit fields 530 may correspond to a codepoint 535 of the set of codepoints 535. For example, bit field 530-a and bit field 530-b may correspond to codepoint 535-a, bit field 530-c and bit field 530-d may correspond to codepoint 535-b, and so on.

The UE may identify a value of each bit field 530 of the first subset of bit fields 530 and a value of each bit field 530 of the second subset of bit fields 530, which may indicate whether a codepoint 535 corresponding to that bit field 530 has a TCI state from the first set of TCI states, a TCI state from the second set of TCI states, or both. For example, if F_{i,j}=1, then codepoint i has a TCI state from TCI state pool j. Otherwise, if F_{i,j}=0, then codepoint i does not have a TCI state from TCI state pool j. As such, a first TCI state ID (e.g., TCI state ID k) associated with a codepoint 535 may be the same as a second TCI state ID (e.g., TCI state ID k+1) associated with the same codepoint 535, however based on the interpretation of the bit fields 530 included in the set of bit fields 530, the UE may have an indication of which set of TCI states a TCI state ID points to. Accordingly, because the bit fields 530 indicate whether a codepoint 535 corresponds to either the first set of TCI states or the second set of TCI states, the UE may receive a single DCI to indicate the TCI states from both the first set of TCI states and the second set of TCI states. Stated alternatively, a single DCI may indicate a first TCI state for use for the first TRP and indicate a second TCI state for use for the second TRP.

As an illustrative example of using the MAC-CE format 500, the UE may receive a MAC-CE that is formatted according to the MAC-CE format 500. If the bit field 530-a has a first bit value (e.g., F_{1,1} equals 1), the UE may have an indication that the first codepoint 535-a is activated and points to a TCI state included in the first set of TCI states. Similarly, if the bit field 530-b has the first bit value (e.g., F_{1,2} equals 1), the UE may have an indication that the first codepoint 535-a is activated and points to a TCI state included in the second set of TCI states. In other cases, if the bit field 530-a has the first bit value (e.g., F_{1,1} equals 1), while the bit field 530-b has a second bit value (e.g., F_{1,2} equals 0), then the UE may have an indication that the first codepoint 535-a is activated and points to a TCI state included in the first set of TCI states, but does not point to a TCI state included in the second set of TCI states.

Each remaining bit field 530 of the set of bit fields included in the first MAC-CE may similarly indicate the status of the corresponding codepoint 535, which may activate TCI states included in the first set of TCI states configured for the first TRP, TCI states included in the second set of TCI states configured for the second TRP, or both. Accordingly, the UE may receive a single DCI that indicates one or more codepoints 535 and may communicate in the downlink direction with the first TRP using the TCI states indicated by the DCI and may communicate with the second TRP in the uplink direction using the TCI states indicated by the DCI.

In some examples, if the UE receives a cell switch MAC-CE that indicates a single TRP for both uplink and downlink communications, the UE may receive a MAC-CE, formatted according to the MAC-CE format 500, where the bit fields 530-b, 530-d, 530-f, 530-h, 530-j, 530-l, 530-n, and 530-p may be set to 0 (e.g., Fᵢ, j =0, for j=2). Additionally, the downlink BWP ID 520-b may be set to 0.

FIG. 6 shows an example of a MAC-CE format 600 that supports enhanced TCI state activation for dual TRP operation. The MAC-CE format 600 (e.g., enhanced unified separate TCI format) may implement, or be implemented by, aspects of the wireless communication system 100, the signaling diagram 200, or both. For example, a UE, a source TRP, a first TRP, and a second TRP, which may be examples of the corresponding device as described herein with reference to FIGS. 1 and 2, may perform enhanced TCI state activation in accordance with the MAC-CE format 600 (e.g., an enhanced unified separate TCI based format).

As described herein with reference to FIG. 2, to perform a decoupled downlink-uplink cell switch operation, the UE may receive control signaling (e.g., cell switch MAC-CE, RRC signaling, or the like) that indicates a first set of TCI states (e.g., TCI state pool 1) configured for a first TRP and a second set of TCI states (e.g., TCI state pool 2) configured for a second TRP. The first TRP may be selected (e.g., by the UE, by the source TRP) for downlink communications while the second TRP may be selected for uplink. To facilitate such communications, and in accordance with the techniques described herein with reference to FIG. 4, the UE may receive a MAC-CE (e.g., from the source TRP) that activates TCI states included in both the first set of TCI states and the second set of TCI states, such that the UE may perform the decoupled cell-switch operation and communicate with the first TRP and the second TRP, respectively.

To do so, the MAC-CE format 600 may include multiple bit fields, including a Serving Cell ID 605 of the serving cell formed by the first TRP and the second TRP, a set of codepoints 640 (e.g., specifying TCI state IDs, codepoints 640-a, 640-b, through 640-n), a downlink BWP ID 620-a associated with the first TRP, a downlink BWP ID 620-b associated with the second TRP, an uplink BWP ID 625-a associated with the first TRP, an uplink BWP ID 625-b associated with the second TRP, a first set of bit fields 630 (e.g., bit fields 630-a, 630-b, 630-c, 630-d, 630-e, 630-f, 630-g, 630-h, 630-i, 630-j, 630-k, 630-l, 630-m, 630-n, 630-o, and 630-p), a second set of bit fields 635 (e.g., bit fields 635-a, 635-b, 635-c, 635-d, 635-e, 635-f, 635-g, 635-h, 635-i, 635-j, 635-k, 635-l, 635-m, 635-n, 635-o, and 635-p), and a set of reserved bits 610 (e.g., formatted as R, reserved bits 610-a, 610-b, 610-c, 610-d, through 610-n).

In such examples, the first set of bit fields 630 may indicate whether a corresponding codepoint 640 indicates a downlink TCI state from the first set of TCI states, a downlink TCI state from the second set of TCI states, or both. For example, the first set of bit fields 630 may include a first subset of bit fields 630 (e.g., F_{i,1}) that correspond to downlink TCI states of the first set of TCI states configured for the first TRP and a second subset of bit fields 630 (e.g., F_{i,2}) that correspond to downlink TCI states of the second set of TCI states configured for the second TRP. In some examples, a single codepoint 640 may correspond to one or more bit fields 630. For example, the bit field 630-a and bit field 630-b may correspond to the codepoint 640-a, bit field 630-c and bit field 630-d may correspond to the codepoint 640-b, and so on.

The UE may identify a value of each bit field 630 of the first set of bit fields 630, which may indicate whether a codepoint 640 corresponding to that bit field 630 has a downlink TCI state from the first set of TCI states, a downlink TCI state from the second set of TCI states, or both. For example, if F_{i,j}=1, then codepoint i has a downlink TCI state from TCI state pool j. Otherwise, if F_{i,j}=0, then codepoint i does not have a downlink TCI state from TCI state pool j.

Similarly, the second set of bit fields 635 may indicate whether a corresponding codepoint 640 indicates an uplink TCI state from the first set of TCI states, an uplink TCI state from the second set of TCI states, or both. For example, the first set of bit fields 635 may include a first subset of bit fields 635 (e.g., S_{i,1}) that correspond to uplink TCI states of the first set of TCI states configured for the first TRP and a second subset of bit fields 635 (e.g., S_{i,2}) that correspond to uplink TCI states of the second set of TCI states configured for the second TRP. In some examples, a single codepoint 640 may correspond to one or more bit fields 635. For example, the bit field 635-a and bit field 635-b may correspond to the codepoint 640-a, bit field 635-c and bit field 635-d may correspond to the codepoint 640-b, and so on.

The UE may identify a value of each bit field 635 of the first set of bit fields 635 which may indicate whether a codepoint 640 corresponding to that bit field 635 has an uplink TCI state from the first set of TCI states, an uplink TCI state from the second set of TCI states, or both. For example, if S_{i,j}=1, then codepoint i has an uplink TCI state from TCI state pool j. Otherwise, if S_{i,j}=0, then codepoint i does not have an uplink TCI state from TCI state pool j. As such, a first TCI state ID (e.g., TCI state ID k) associated with a codepoint 640 may be the same as a second TCI state ID (e.g., TCI state ID k+1) associated with the same codepoint 535, however based on the interpretation of the bit fields 630 and 635, the UE may have an indication of which set of TCI states a TCI state ID points to. Accordingly, because the bit fields 630 and 635 indicate whether a codepoint 640 corresponds to either the first set of TCI states or the second set of TCI states, the UE may receive a single DCI to indicate the TCI states from both the first set of TCI states and the second set of TCI states. Stated alternatively, a single DCI may indicate one or more first TCI states for use for the first TRP and indicate one or more second TCI states for use for the second TRP.

As an illustrative example of using the MAC-CE format 600, the UE may receive a MAC-CE that is formatted according to the MAC-CE format 600. If the bit field 630-a has a first bit value (e.g., F_{1,1} equals 1), the UE may have an indication that the first codepoint 640-a is activated and points to a downlink TCI state included in the first set of TCI states. If the bit field 630-b also has the first bit value (e.g., F_{1,2} equals 1), the UE may have an indication that the first codepoint 640-a is activated and points to a downlink TCI state included in the second set of TCI states. Alternatively, if the bit field 630-a has the first bit value (e.g., F_{1,1} equals 1), while the bit field 630-b has a second bit value (e.g., F_{1,2} equals 0), then the UE may have an indication that the first codepoint 640-a is activated and points to a downlink TCI state included in the first set of TCI states, but does not point to a downlink TCI state included in the second set of TCI states. Each remaining bit field 630 of the first set of bit fields 630 included in the first MAC-CE may similarly indicate the status of the corresponding codepoint 640, which may indicate downlink TCI states included in the first set of TCI states configured for the first TRP, downlink TCI states included in the second set of TCI states configured for the second TRP, or both.

Additionally, if the bit field 635-a has a first bit value (e.g., S_{1,1} equals 1), the UE may have an indication that the first codepoint 640-a is activated and also points to an uplink TCI state included in the first set of TCI states. If the bit field 635-b also has the first bit value (e.g., S_{1,2} equals 1), the UE may have an indication that the first codepoint 640-a is activated and also points to an uplink TCI state included in the second set of TCI states. Alternatively, if the bit field 635-a has the first bit value (e.g., S_{1,1} equals 1), while the bit field 635-b has a second bit value (e.g., S_{1,2} equals 0), then the UE may have an indication that the first codepoint 640-a is activated and points to an uplink TCI state included in the first set of TCI states, but does not point to an uplink TCI state included in the second set of TCI states. Each remaining bit field 635 of the second set of bit fields 635 included in the first MAC-CE may similarly indicate the status of the corresponding codepoint 640, which may indicate uplink TCI states included in the first set of TCI states configured for the first TRP, uplink TCI states included in the second set of TCI states configured for the second TRP, or both.

Accordingly, the UE may receive DCI that indicates a codepoint 640 included in the set of codepoints 640, where the codepoint 640 indicates one or more downlink TCI states from the first set of TCI states, one or more downlink TCI states from the second set of TCI states, one or more uplink TCI states of the first set of TCI states, one or more uplink TCI states of the second set of TCI states, or any combination thereof according to the MAC-CE. The UE may communicate with the first TRP using at least one downlink TCI state from the first set of TCI states, at least one downlink TCI state from the second TCI states, or both. Similarly, the UE may communicate with the second TRP using at least one uplink TCI state from the first set of TCI states, at least one uplink TCI state from the second set of TCI states, or both.

In some examples, if the UE receives a cell switch MAC-CE that indicates a single TRP for both uplink and downlink communications, the UE may receive a MAC-CE, formatted according to the MAC-CE format 600, where the bit fields 630-b, 630-d, 630-f, 630-h, 630-j, 630-k, 630-l, 630-n, 630-p, 635-b, 635-d, 635-f, 635-h, 635-j, 635-k, 635-l, 635-n, 635-p set to 0 (e.g., Fi,j=0, for j=2 and Si,j=0, for j=2). Additionally, the downlink BWP ID 620-b and/or uplink BWP ID 625-b may be set to 0.

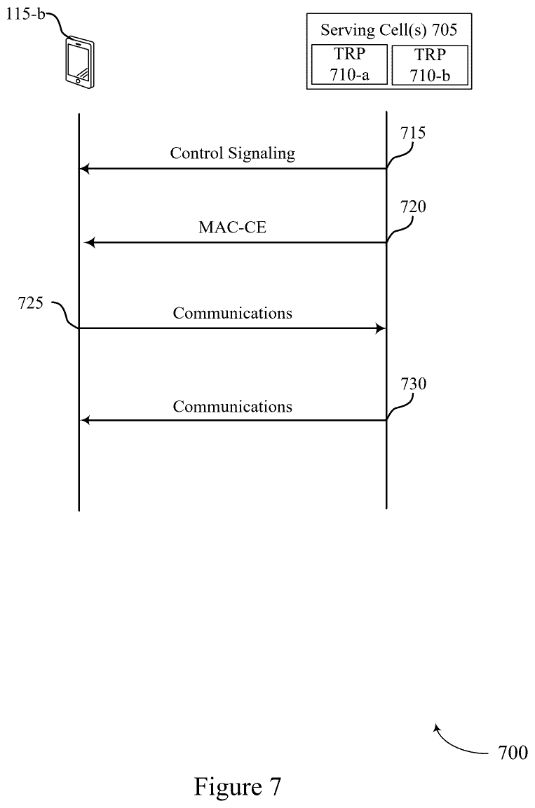

FIG. 7 shows an example of a process flow 700 that supports enhanced TCI state activation for dual TRP operation. Aspects of the process flow 700 may implement, or be implemented by, aspects of the wireless communication system 100, the signaling diagram 200, or the MAC-CE formats 300-600, as described herein with reference to FIG. 1-6. For example, the process flow 700 may include a UE 115-b, and a serving cell 705, which is formed by, or includes, a first TRP 710-a, and a second TRP 710-b, which may be examples of the corresponding devices as described herein. In the following description of the process flow 700, the operations between the UE 115-b, the first TRP 710-a, and the second TRP 710-b may be communicated in a different order than the example order shown, or the operations may be performed in different orders or at different times. Some operations may also be omitted from the process flow 700, and other operations may be added to the process flow 700.

At 715, the UE 115-b may receive control signaling that indicates a first set of TCI states configured for the first TRP 710-a and a second set of TCI sates configured for the second TRP 710-b, where the UE 115-b communicates downlink communications with the first TRP 710-a and communicates uplink communications with the second TRP 710-b. The first TRP 710-a and the second TRP 710-b may be selected for a decoupled cell switch operation based on one or more metrics associated with communications between the first TRP 710-a and the second TRP 710-b satisfying one or more thresholds.

At 720, the UE 115-b may receive a MAC-CE that activates one or more first TCI states of the first set of TCI states and activates one or more second TCI states of the one or more second TCI states. For example, the MAC-CE may activate a first set of codepoints corresponding to the first set of TCI states, the second set of TCI states, or both. Additionally, the MAC-CE may include one or more sets of bits fields, where the value of each bit fields within the one or more sets of bit fields indicates whether a codepoint corresponding to the bit field includes a TCI state from the first set of TCI states, a TCI state from the second set of TCI states, or both. In such examples, the MAC-CE may be formatted according to MAC-CE formats 400, 500, or 600 as described herein.

At 725, the UE 115-b may communicate with the first TRP 710-a using at least one TCI state of the first set of TCI states activated by the MAC-CE. At 730, the UE may communicate with the second TRP 710-b using at least one TCI state of the second set of TCI states. As such, the UE 115-b may perform a decoupled-cell switch operation according to the MAC-CE received at 720, which may enable the UE 115-b to communicate with the first TRP 710-a suited for the downlink communication direction and the second TRP 710-b suited for the uplink communication direction.

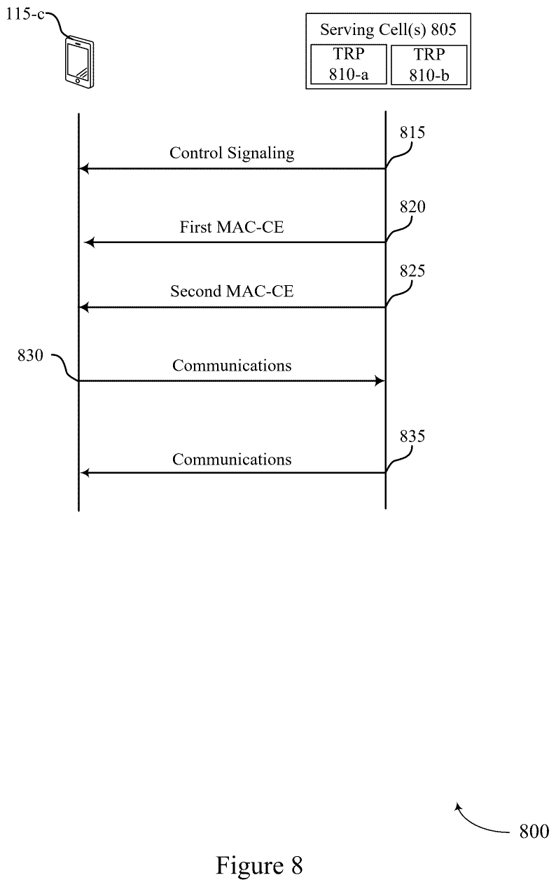

FIG. 8 shows an example of a process flow 800 that supports enhanced TCI state activation for dual TRP operation. Aspects of the process flow 800 may implement, or be implemented by, aspects of the wireless communication system 100, the signaling diagram 200, or the MAC-CE formats 300-600, as described herein with reference to FIG. 1-6. For example, the process flow 800 may include a UE 115-c and a serving cell 805, which may be formed by, or otherwise include, a first TRP 810-a, and a second TRP 810-b, which may be examples of the corresponding devices as described herein. In the following description of the process flow 800, the operations between the UE 115-c and the serving cell(s) 805 may be communicated in a different order than the example order shown, or the operations performed by the UE 115-b, the first TRP 810-a, and the second TRP 810-b may be performed in different orders or at different times. Some operations may also be omitted from the process flow 800, and other operations may be added to the process flow 800.

At 815, the UE 115-c may receive control signaling that indicates a first set of TCI states configured for the first TRP 810-a and a second set of TCI sates configured for the second TRP 810-b, where the UE 115-c communicates downlink communications with the first TRP 810-a, and wherein the UE 115-c communicates uplink communications with the second TRP 810-b. The first TRP 810-a and the second TRP 810-b may be selected for a decoupled cell switch operation based on one or more metrics associated with communications between the first TRP 810-a and the second TRP 810-b satisfying one or more thresholds.

At 820, the UE 115-c may receive a first MAC-CE that activates a first set of codepoints that correspond to the first set of TCI states in accordance with a first bit of the MAC-CE having a first value. At 825, receive a second MAC-CE that activates a second set of codepoints that correspond to the second set of TCI states in accordance with a first bit of the second MAC-CE having a second value that is different from the first value. In such examples, the first MAC-CE, the second MAC-CE, or both may be formatted according to MAC-CE format 300 as described herein.

At 830, the UE 115-c may communicate with the first TRP 810-a using at least one TCI state of the first set of TCI states activated by the first MAC-CE. At 835, the UE 115-c may communicate with the second TRP 810-b using at least one TCI state of the second set of TCI states. As such, the UE 115-c may perform a decoupled-cell switch operation according to the first MAC-CE and the second MAC-CE, which may enable the UE 115-c to communicate with the first TRP 810-a suited for the downlink communication direction and the second TRP 810-b suited for the uplink communication direction.

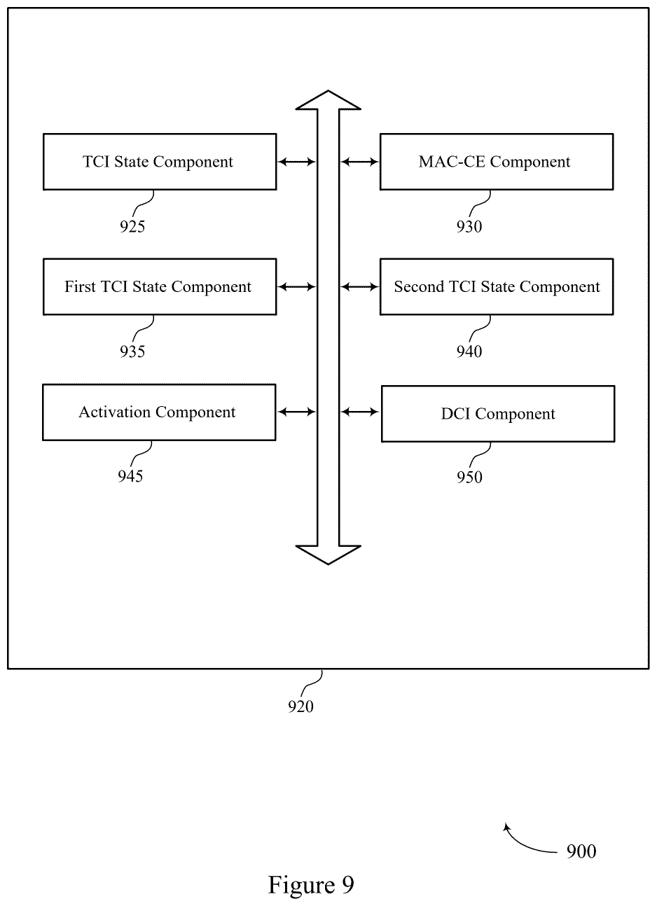

FIG. 9 shows an example 900 of a processing system 920 that supports enhanced TCI state activation for dual TRP operation. A processing system 920 may be an example of a processing system 140 (such as of a UE 115) and may include a TCI state component 925, a MAC-CE component 930, a first TCI state component 935, a second TCI state component 940, an activation component 945, and a DCI component 950, or any combination thereof. A processing system 920, or various component thereof, may be an example of means for performing (such as a means for causing a UE 115 to perform) various techniques described herein.

The TCI state component 925 may be configured to cause the UE 115 to receive control signaling indicating a first set of TCI states configured for a first TRP and a second set of TCI states configured for a second TRP, where the UE performs downlink communications with the first TRP, and where the UE performs uplink communications with the second TRP. The MAC-CE component 930 may be configured to cause the UE 115 to receive a MAC-CE that activates one or more first TCI states of the first set of TCI states and activates one or more second TCI states of the second set of TCI states. The first TCI state component 935 may be configured to cause the UE 115 to communicate with the first TRP using at least one TCI state of the one or more first TCI states in accordance with the MAC-CE. The second TCI state component 940 may be configured to cause the UE 115 to communicate with the second TRP using at least one TCI state of the one or more second TCI states based on the MAC-CE.

In some examples, the activation component 945 may be configured to cause the UE 115 to activate, via the MAC-CE, a first set of codepoints that correspond to the first set of TCI states and a second set of codepoints that correspond to the second set of TCI states.

In some examples, the DCI component 950 may be configured to cause the UE 115 to receive first DCI that indicates a first codepoint of the first set of codepoints in accordance with a first bit of the first DCI having a first bit value, where the first codepoint indicates the at least one TCI state of the one or more first TCI states.

In some examples, the DCI component 950 may be configured to cause the UE 115 to receive second DCI that indicates a second codepoint of the second set of codepoints in accordance with a first bit of the second DCI having a second bit value that is different from the first bit value, where the second codepoint indicates the one or more second TCI states.

In some examples, the MAC-CE includes a first set of bit fields, each bit field of the first set of bit fields corresponding to a respective codepoint of the first set of codepoints. In some examples, the MAC-CE includes a second set of bit fields, each bit field of the second set of bit fields corresponds to a respective codepoint of the second set of codepoints. In some examples, a first value of a bit field of the first set of bit fields or the second set of bit fields indicates that a corresponding codepoint indicates an uplink TCI state and a downlink TCI state. In some examples, a second value of the bit field indicates that the corresponding codepoint indicates a downlink TCI state, a joint TCI state, or an uplink TCI state.

In some examples, the activation component 945 may be configured to cause the UE 115 to activate, via the MAC-CE, a set of codepoints that correspond to both the first set of TCI states and the second set of TCI states, where each codepoint of the set of codepoints corresponds to one of the first set of TCI states, one of the second set of TCI states, or both in accordance with a first set of bit fields of the MAC-CE, a second set of bit fields of the MAC-CE, or both.

In some examples, the activation component 945 may be configured to cause the UE 115 to receive a first DCI that indicates a first codepoint of the set of codepoints, where the first codepoint indicates the at least one TCI state of the one or more first TCI states, the at least one TCI state of the one or more second TCI states, or both.

In some examples, the DCI component 950 may be configured to cause the UE 115 to receive a second DCI that indicates a second codepoint of the set of codepoints, where the second codepoint indicates the at least one TCI state of the one or more first TCI states or the at least one TCI state of the one or more second TCI states based on the first DCI.

In some examples, a first subset of bit fields of the first set of bit fields corresponds to the first set of TCI states. In some examples, a second subset of bit fields of the first set of bit fields corresponds to the second set of TCI states. In some examples, a first codepoint of the set of codepoints indicates one or more TCI states from the first set of TCI states, the one or more TCI states from the second set of TCI states, or both in accordance with a corresponding bit field of the first subset of bit fields having a first value, in accordance with a corresponding bit field of the second subset of bit fields having the first value, or both.

In some examples, a second codepoint of the set of codepoints indicates the one or more TCI states from the first set of TCI states in accordance with the corresponding bit field of the first subset of bit fields having the first value and in accordance with the corresponding bit field of the second subset of bit fields having a second value different from the first value.

In some examples, a first subset of bit fields of the first set of bit fields corresponds to downlink TCI states of the first set of TCI states. In some examples, a second subset of bit fields of the first set of bit fields corresponds to downlink TCI states of the second set of TCI states. In some examples, a first codepoint of the set of codepoints indicates one or more of the downlink TCI states from the first set of TCI states, one or more downlink TCI states from the second set of TCI states, or both in accordance with a corresponding bit field of the first subset of bit fields having a first value, in accordance with a corresponding bit field of the second subset of bit fields having the first value, or both.

In some examples, a second codepoint of the set of codepoints indicates the one or more downlink TCI states from the first set of TCI states in accordance with the corresponding bit field of the first subset of bit fields having the first value and in accordance with the corresponding bit field of the second subset of bit fields having a second value different from the first value.

In some examples, a first subset of bit fields of the second set of bit fields corresponds to uplink TCI states of the first set of TCI states. In some examples, a second subset of bit fields of the second set of bit fields corresponds to uplink TCI states of the second set of TCI states. In some examples, a first codepoint of the set of codepoints indicates one or more of the uplink TCI states from the first set of TCI states, one or more uplink TCI states from the second set of TCI states, or both in accordance with a corresponding bit field of the first subset of bit fields having a first value and in accordance with a corresponding bit field of the second subset of bit fields having the first value.

In some examples, a second codepoint of the set of codepoints indicates the one or more uplink TCI states from the first set of TCI states in accordance with the corresponding bit field of the first subset of bit fields having the first value and in accordance with the corresponding bit field of the second subset of bit fields having a second value different from the first value.

Additionally, or alternatively, the TCI state component 925 may be configured to cause the UE 115 to receive control signaling indicating a first set of TCI states configured for a first TRP and a second set of TCI states configured for a second TRP, where the UE performs downlink communications with the first TRP, and where the UE performs uplink communications with the second TRP. The MAC-CE component 930 may be configured to cause the UE 115 to receive a first MAC-CE that activates a first set of codepoints that correspond to the first set of TCI states in accordance with a first bit of the MAC-CE having a first value. In some examples, the MAC-CE component 930 may be configured to cause the UE 115 to receive a second MAC-CE that activates a second set of codepoints that correspond to the second set of TCI states in accordance with a first bit of the second MAC-CE having a second value that is different from the first value. The first TCI state component 935 may be configured to cause the UE 115 to communicate with the first TRP using one or more first TCI states of the first set of TCI states in accordance with the first MAC-CE. In some examples, the second TCI state component 940 may be configured to cause the UE 115 to communicate with the second TRP using one or more second TCI states of the second set of TCI states in accordance with the second MAC-CE.

In some examples, the DCI component 950 may be configured to cause the UE 115 to receive DCI that indicates a first codepoint of the first set of codepoints in accordance with a first bit of the DCI having the first bit value, where the first codepoint indicates the one or more first TCI states.

In some examples, the DCI component 950 may be configured to cause the UE 115 to receive DCI that indicates a first codepoint of the second set of codepoints in accordance with a first bit of the DCI having the second bit value, where the first codepoint indicates the one or more second TCI states.

In some examples, the first MAC-CE includes a set of bit fields. In some examples, each bit field of the set of bit fields corresponds to a respective codepoint of the first set of codepoints. In some examples, a first value of a first bit field of the set of bit fields indicates that a corresponding codepoint of the first set of codepoints indicates an uplink TCI state and a downlink TCI state. In some examples, a second value of the first bit field indicates that the corresponding codepoint indicates a downlink TCI state, a joint TCI state, or an uplink TCI state.

In some examples, the second MAC-CE includes a set of bit fields. In some examples, each bit field of the set of bit fields corresponds to a respective codepoint of the second set of codepoints. In some examples, a first value of a first bit field of the set of bit fields indicates that a corresponding codepoint of the second set of codepoints indicates an uplink TCI state and a downlink TCI state. In some examples, a second value of the first bit field indicates that the corresponding codepoint indicates a downlink TCI state, a joint TCI state, or an uplink TCI state.

A processing system 920 may include or be a component of one or more chips, systems-on-chips (SoCs), chipsets, packages, components, or devices that individually or collectively constitute or include a processing system. A processing system 920 may interface with other components of a processing system 920. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a processing system 920).

By including or configuring a processing system 920 for operation in a processing system 920 as described herein, the processing system 920 may support techniques for efficient and accurate decoupled downlink-uplink cell switch.

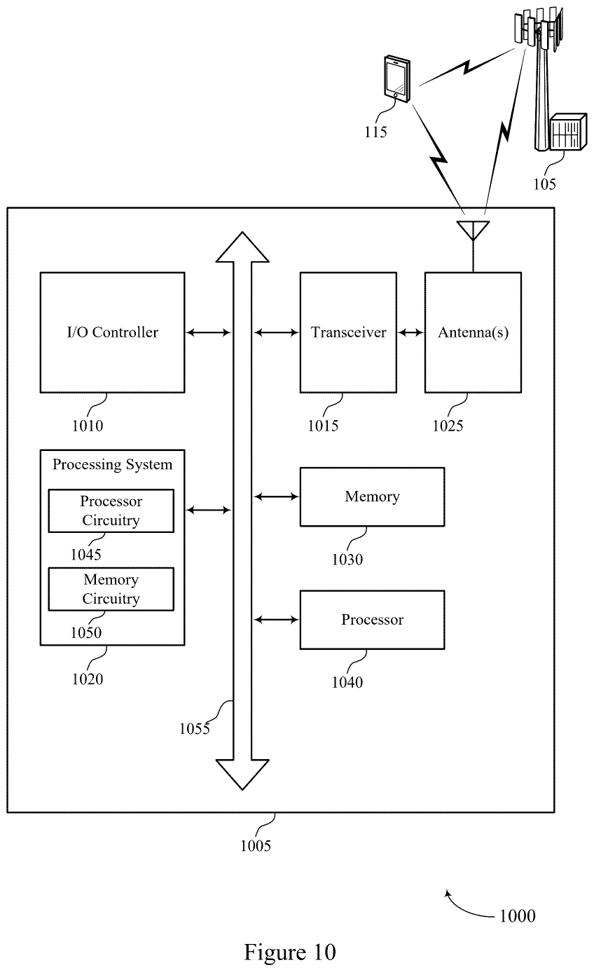

FIG. 10 shows an example of a system 1000 including a device 1005 that supports enhanced TCI state activation for dual TRP operation. The device 1005 may be an example of or include components of UE 115. The device 1005 may communicate (such as wirelessly) with one or more other devices (such as network entities 105, UEs 115). The device 1005 may include components for transmitting and receiving communication, which may include a processing system 1020, an input/output (I/O) controller, such as an I/O controller 1010, a transceiver 1015, antenna(s) 1025, a memory 1030, and a processor 1040. Components of the device 1005 may be coupled (such as operatively, communicatively, functionally, electronically, electrically, in electronic communication) a bus 1055.

The transceiver 1015 may support bi-directional communication via antenna(s) 1025, and may support transmission operations, reception operations, or both, as described herein. The transceiver 1015 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1005). The transceiver 1015 may modulate symbols and provide the modulated symbols to antenna(s) 1025 for transmission, and demodulate symbols from signals received using antenna(s) 1025.

The processor 1040 may be a general-purpose processing component that supports various operations (such as applications) of the device 1005. The memory 1030 may be a general-purpose storage component that stores code executable by the processor 1040. Such code may include instructions that, when executed by the processor 1040, cause the device 1005 to perform various functions (such as to support an application of the device 1005). The I/O controller 1010 may manage inputs and outputs for the device 1005, may manage peripherals not integrated into the device 1005, or may represent a physical connection (such as port) to an external peripheral. The processor 1040 may interact with a modem, a keyboard, a mouse, a touchscreen, or other device (such as via I/O controller 1010). In some implementations, a user may interact with the device 1005 via the I/O controller 1010 or via hardware components controlled by the I/O controller 1010.

The processing system 1020 may be an example of a processing system 140 or a processing system 920. For example, the processing system 1020 may include processor circuitry 1045 and memory circuitry 1050 that stores code, and may be configured to cause the device 1005 to perform operations that support enhanced TCI state activation for dual TRP operation. Although the processing system 1020 is illustrated as a separate component, which may involve a separate chip, chipset, or other module, in some implementations, one or more functions described with reference to the processing system 1020 may be supported by or performed by a transceiver 1015, antenna(s) 1025, a processor 1040, memory 1030, or any combination thereof, such that a processing system 1020 may include one or more of a transceiver 1015, antenna(s) 1025, a processor 1040, memory 1030, or any combination thereof.

By including or configuring the processing system 1020 for operation in the device 1005 as described herein, may support techniques for efficient and accurate decoupled downlink-uplink cell switch.

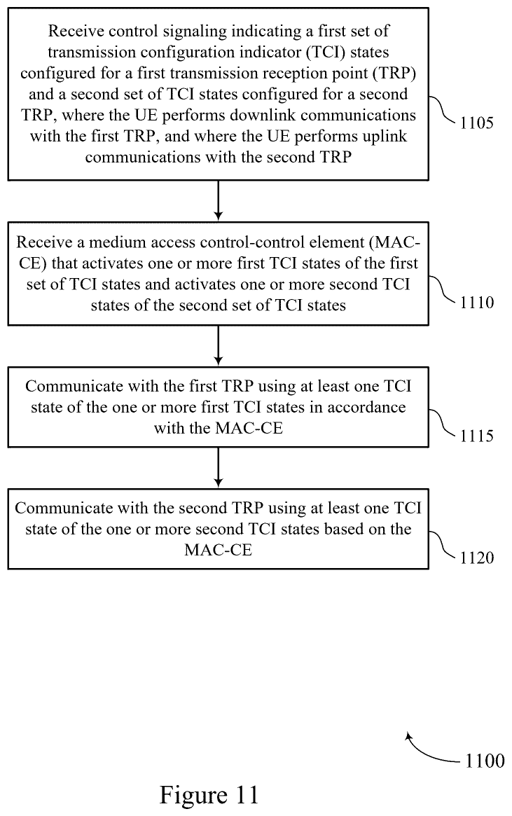

FIG. 11 shows an example of a method 1100 that supports enhanced TCI state activation for dual TRP operation. Operations of the method 1100 may be performed by a UE or its components (such as using a processing system configured to cause the UE 115 to perform one or more of the operations) as described herein.

At 1105, the method may include receiving control signaling indicating a first set of TCI states configured for a TRP and a second set of TCI states configured for a second TRP, where the UE performs downlink communications with the first TRP, and where the UE performs uplink communications with the second TRP. In some examples, aspects of the operations of 1105 may be performed by a TCI state component 925.

At 1110, the method may include receiving a MAC-CE that activates one or more first TCI states of the first set of TCI states and activates one or more second TCI states of the second set of TCI states. In some examples, aspects of the operations of 1110 may be performed by a MAC-CE component 930.

At 1115, the method may include communicating with the first TRP using at least one TCI state of the one or more first TCI states in accordance with the MAC-CE. In some examples, aspects of the operations of 1115 may be performed by a first TCI state component 935.

At 1120, the method may include communicating with the second TRP using at least one TCI state of the one or more second TCI states based on the MAC-CE. In some examples, aspects of the operations of 1120 may be performed by a second TCI state component 940.

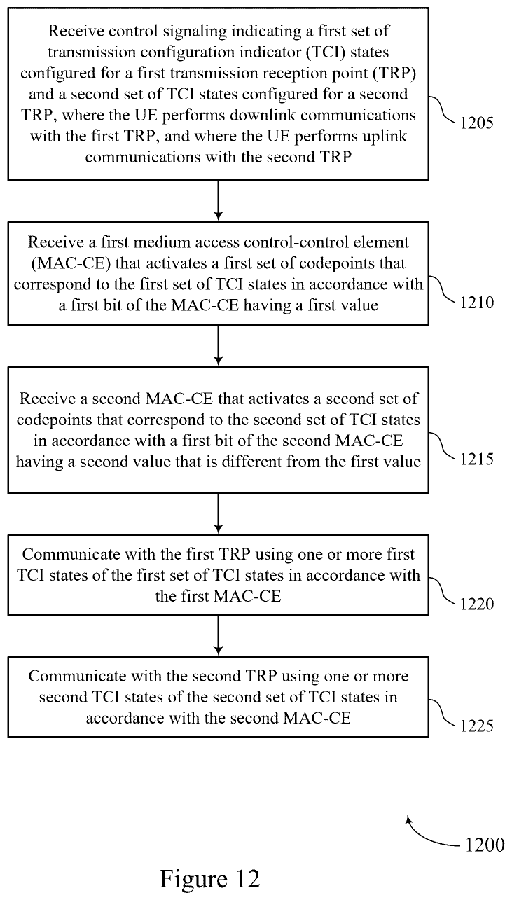

FIG. 12 shows an example of a method 1200 that supports enhanced TCI state activation for dual TRP operation. Operations of the method 1200 may be performed by a UE or its components (such as using a processing system configured to cause the UE 115 to perform one or more of the operations) as described herein.

At 1205, the method may include receiving control signaling indicating a first set of TCI states configured for a first TRP and a second set of TCI states configured for a second TRP, where the UE performs downlink communications with the first TRP, and where the UE performs uplink communications with the second TRP. In some examples, aspects of the operations of 1205 may be performed by a TCI state component 925.

At 1210, the method may include receiving a first MAC-CE that activates a first set of codepoints that correspond to the first set of TCI states in accordance with a first bit of the MAC-CE having a first value. In some examples, aspects of the operations of 1210 may be performed by a MAC-CE component 930.

At 1215, the method may include receiving a second MAC-CE that activates a second set of codepoints that correspond to the second set of TCI states in accordance with a first bit of the second MAC-CE having a second value that is different from the first value. In some examples, aspects of the operations of 1215 may be performed by a MAC-CE component 930.

At 1220, the method may include communicating with the first TRP using one or more first TCI states of the first set of TCI states in accordance with the first MAC-CE. In some examples, aspects of the operations of 1220 may be performed by a first TCI state component 935.

At 1225, the method may include communicating with the second TRP using one or more second TCI states of the second set of TCI states in accordance with the second MAC-CE. In some examples, aspects of the operations of 1225 may be performed by a second TCI state component 940.

Implementation examples are described in the following numbered clauses:

Aspect 1: A method for wireless communications at a UE, comprising: receiving control signaling indicating a first set of TCI states configured for a first TRP and a second set of TCI states configured for a second TRP, wherein the UE performs downlink communications with the first TRP, and wherein the UE performs uplink communications with the second TRP; receiving a MAC-CE that activates one or more first TCI states of the first set of TCI states and activates one or more second TCI states of the second set of TCI states; communicating with the first TRP using at least one TCI state of the one or more first TCI states in accordance with the MAC-CE; and communicating with the second TRP using at least one TCI state of the one or more second TCI states based at least in part on the MAC-CE.

Aspect 2: The method of aspect 1, wherein, to activate the one or more first TCI states and the one or more second TCI states, the method further comprises: activating, via the MAC-CE, a first set of codepoints that correspond to the first set of TCI states and a second set of codepoints that correspond to the second set of TCI states.

Aspect 3: The method of aspect 2, further comprising: receiving first DCI that indicates a first codepoint of the first set of codepoints in accordance with a first bit of the first DCI having a first bit value, wherein the first codepoint indicates the at least one TCI state of the one or more first TCI states.

Aspect 4: The method of aspect 3, further comprising: receiving second DCI that indicates a second codepoint of the second set of codepoints in accordance with a first bit of the second DCI having a second bit value that is different from the first bit value, wherein the second codepoint indicates the one or more second TCI states.

Aspect 5: The method of any of aspects 2 through 4, wherein the MAC-CE comprises a first set of bit fields, each bit field of the first set of bit fields corresponding to a respective codepoint of the first set of codepoints, the MAC-CE comprises a second set of bit fields, each bit field of the second set of bit fields corresponds to a respective codepoint of the second set of codepoints, a first value of a bit field of the first set of bit fields or the second set of bit fields indicates that a corresponding codepoint indicates an uplink TCI state and a downlink TCI state, and a second value of the bit field indicates that the corresponding codepoint indicates a downlink TCI state, a joint TCI state, or an uplink TCI state.

Aspect 6: The method of aspect 1, wherein, to activate the one or more first TCI states and the one or more second TCI states, the method further comprises: activating, via the MAC-CE, a set of codepoints that correspond to both the first set of TCI states and the second set of TCI states, wherein each codepoint of the set of codepoints corresponds to one of the first set of TCI states, one of the second set of TCI states, or both in accordance with a first set of bit fields of the MAC-CE, a second set of bit fields of the MAC-CE, or both.

Aspect 7: The method of aspect 6, further comprising: receiving a first DCI that indicates a first codepoint of the set of codepoints, wherein the first codepoint indicates the at least one TCI state of the one or more first TCI states, the at least one TCI state of the one or more second TCI states, or both.

Aspect 8: The method of aspect 7, further comprising: receiving a second DCI that indicates a second codepoint of the set of codepoints, wherein the second codepoint indicates the at least one TCI state of the one or more first TCI states or the at least one TCI state of the one or more second TCI states based at least in part on the first DCI.

Aspect 9: The method of any of aspects 6 through 8, wherein a first subset of bit fields of the first set of bit fields correspond to the first set of TCI states, a second subset of bit fields of the first set of bit fields correspond to the second set of TCI states, and a first codepoint of the set of codepoints indicates one or more TCI states from the first set of TCI states, the one or more TCI states from the second set of TCI states, or both in accordance with a corresponding bit field of the first subset of bit fields having a first value, in accordance with a corresponding bit field of the second subset of bit fields having the first value, or both.

Aspect 10: The method of aspect 9, wherein a second codepoint of the set of codepoints indicates the one or more TCI states from the first set of TCI states in accordance with the corresponding bit field of the first subset of bit fields having the first value and in accordance with the corresponding bit field of the second subset of bit fields having a second value different from the first value.

Aspect 11: The method of any of aspects 6 through 10, wherein a first subset of bit fields of the first set of bit fields correspond to downlink TCI states of the first set of TCI states, a second subset of bit fields of the first set of bit fields correspond to downlink TCI states of the second set of TCI states, and a first codepoint of the set of codepoints indicates one or more of the downlink TCI states from the first set of TCI states, one or more downlink TCI states from the second set of TCI states, or both in accordance with a corresponding bit field of the first subset of bit fields having a first value, in accordance with a corresponding bit field of the second subset of bit fields having the first value, or both.

Aspect 12: The method of aspect 11, wherein a second codepoint of the set of codepoints indicates the one or more downlink TCI states from the first set of TCI states in accordance with the corresponding bit field of the first subset of bit fields having the first value and in accordance with the corresponding bit field of the second subset of bit fields having a second value different from the first value.

Aspect 13: The method of any of aspects 6 through 12, wherein a first subset of bit fields of the second set of bit fields correspond to uplink TCI states of the first set of TCI states, a second subset of bit fields of the second set of bit fields correspond to uplink TCI states of the second set of TCI states, and a first codepoint of the set of codepoints indicates one or more of the uplink TCI states from the first set of TCI states, one or more uplink TCI states from the second set of TCI states, or both in accordance with a corresponding bit field of the first subset of bit fields having a first value and in accordance with a corresponding bit field of the second subset of bit fields having the first value.

Aspect 14: The method of aspect 13, wherein a second codepoint of the set of codepoints indicates the one or more uplink TCI states from the first set of TCI states in accordance with the corresponding bit field of the first subset of bit fields having the first value and in accordance with the corresponding bit field of the second subset of bit fields having a second value different from the first value.

Aspect 15: A method for wireless communications at a UE, comprising: receiving control signaling indicating a first set of TCI states configured for a first TRP and a second set of TCI states configured for a second TRP, wherein the UE performs downlink communications with the first TRP, and wherein the UE performs uplink communications with the second TRP; receiving a first MAC-CE that activates a first set of codepoints that correspond to the first set of TCI states in accordance with a first bit of the MAC-CE having a first value; receiving a second MAC-CE that activates a second set of codepoints that correspond to the second set of TCI states in accordance with a first bit of the second MAC-CE having a second value that is different from the first value; communicating with the first TRP using one or more first TCI states of the first set of TCI states in accordance with the first MAC-CE; and communicating with the second TRP using one or more second TCI states of the second set of TCI states in accordance with the second MAC-CE.

Aspect 16: The method of aspect 15, further comprising: receiving DCI that indicates a first codepoint of the first set of codepoints in accordance with a first bit of the DCI having the first bit value, wherein the first codepoint indicates the one or more first TCI states.

Aspect 17: The method of any of aspects 15 through 16, further comprising: receiving DCI that indicates a first codepoint of the second set of codepoints in accordance with a first bit of the DCI having the second bit value, wherein the first codepoint indicates the one or more second TCI states.

Aspect 18: The method of any of aspects 15 through 17, wherein the first MAC-CE comprises a set of bit fields, each bit field of the set of bit fields corresponds to a respective codepoint of the first set of codepoints, a first value of a first bit field of the set of bit fields indicates that a corresponding codepoint of the first set of codepoints indicates an uplink TCI state and a downlink TCI state, and a second value of the first bit field indicates that the corresponding codepoint indicates a downlink TCI state, a joint TCI state, or an uplink TCI state.

Aspect 19: The method of any of aspects 15 through 18, wherein the second MAC-CE comprises a set of bit fields, each bit field of the set of bit fields corresponds to a respective codepoint of the second set of codepoints, a first value of a first bit field of the set of bit fields indicates that a corresponding codepoint of the second set of codepoints indicates an uplink TCI state and a downlink TCI state, and a second value of the first bit field indicates that the corresponding codepoint indicates a downlink TCI state, a joint TCI state, or an uplink TCI state.

Aspect 20: A UE for wireless communications, comprising a processing system that includes processor circuitry and memory circuitry that stores code, the processing system configured to cause the UE to perform a method of any of aspects 1 through 14.

Aspect 21: A UE for wireless communications, comprising at least one means for performing a method of any of aspects 1 through 14.

Aspect 22: A non-transitory computer-readable medium storing code for wireless communications, the code comprising instructions executable by one or more processors to perform a method of any of aspects 1 through 14.

Aspect 23: A UE for wireless communications, comprising a processing system that includes processor circuitry and memory circuitry that stores code, the processing system configured to cause the UE to perform a method of any of aspects 15 through 19.

Aspect 24: A UE for wireless communications, comprising at least one means for performing a method of any of aspects 15 through 19.

Aspect 25: A non-transitory computer-readable medium storing code for wireless communications, the code comprising instructions executable by one or more processors to perform a method of any of aspects 15 through 19.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and formats described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling indicating a first set of transmission configuration indicator (TCI) states configured for a first transmission reception point (TRP) and a second set of TCI states configured for a second TRP, wherein the UE performs downlink communications with the first TRP, and wherein the UE performs uplink communications with the second TRP;
receive a medium access control-control element (MAC-CE) that activates one or more first TCI states of the first set of TCI states and activates one or more second TCI states of the second set of TCI states;
communicate with the first TRP using at least one TCI state of the one or more first TCI states in accordance with the MAC-CE; and
communicate with the second TRP using at least one TCI state of the one or more second TCI states based at least in part on the MAC-CE.

2. The UE of claim 1, wherein the processing system is further configured to cause the UE to:
activate, via the MAC-CE, a first set of codepoints that correspond to the first set of TCI states and a second set of codepoints that correspond to the second set of TCI states.

3. The UE of claim 2, wherein the processing system is further configured to cause the UE to:
receive first downlink control information (DCI) that indicates a first codepoint of the first set of codepoints in accordance with a first bit of the first DCI having a first bit value, wherein the first codepoint indicates the at least one TCI state of the one or more first TCI states.

4. The UE of claim 3, wherein the processing system is further configured to cause the UE to:
receive second DCI that indicates a second codepoint of the second set of codepoints in accordance with a first bit of the second DCI having a second bit value that is different from the first bit value, wherein the second codepoint indicates the one or more second TCI states.

5. The UE of claim 2, wherein:
the MAC-CE comprises a first set of bit fields, each bit field of the first set of bit fields corresponding to a respective codepoint of the first set of codepoints,
the MAC-CE comprises a second set of bit fields, each bit field of the second set of bit fields corresponds to a respective codepoint of the second set of codepoints,
a first value of a bit field of the first set of bit fields or the second set of bit fields indicates that a corresponding codepoint indicates an uplink TCI state and a downlink TCI state, and
a second value of the bit field indicates that the corresponding codepoint indicates a downlink TCI state, a joint TCI state, or an uplink TCI state.

6. The UE of claim 1, wherein the processing system is further configured to cause the UE to:
activate, via the MAC-CE, a set of codepoints that correspond to both the first set of TCI states and the second set of TCI states, wherein each codepoint of the set of codepoints corresponds to one of the first set of TCI states, one of the second set of TCI states, or both in accordance with a first set of bit fields of the MAC-CE, a second set of bit fields of the MAC-CE, or both.

7. The UE of claim 6, wherein the processing system is further configured to cause the UE to:
receive a first downlink control information (DCI) that indicates a first codepoint of the set of codepoints, wherein the first codepoint indicates the at least one TCI state of the one or more first TCI states, the at least one TCI state of the one or more second TCI states, or both.

8. The UE of claim 7, wherein the processing system is further configured to cause the UE to:
receive a second DCI that indicates a second codepoint of the set of codepoints, wherein the second codepoint indicates the at least one TCI state of the one or more first TCI states or the at least one TCI state of the one or more second TCI states based at least in part on the first DCI.

9. The UE of claim 6, wherein:
a first subset of bit fields of the first set of bit fields corresponds to the first set of TCI states,
a second subset of bit fields of the first set of bit fields correspond to the second set of TCI states, and
a first codepoint of the set of codepoints indicates one or more TCI states from the first set of TCI states, the one or more TCI states from the second set of TCI states, or both in accordance with a corresponding bit field of the first subset of bit fields having a first value, in accordance with a corresponding bit field of the second subset of bit fields having the first value, or both.

10. The UE of claim 9, wherein a second codepoint of the set of codepoints indicates the one or more TCI states from the first set of TCI states in accordance with the corresponding bit field of the first subset of bit fields having the first value and in accordance with the corresponding bit field of the second subset of bit fields having a second value different from the first value.

11. The UE of claim 6, wherein:
a first subset of bit fields of the first set of bit fields corresponds to downlink TCI states of the first set of TCI states,
a second subset of bit fields of the first set of bit fields corresponds to downlink TCI states of the second set of TCI states, and
a first codepoint of the set of codepoints indicates one or more of the downlink TCI states from the first set of TCI states, one or more downlink TCI states from the second set of TCI states, or both in accordance with a corresponding bit field of the first subset of bit fields having a first value, in accordance with a corresponding bit field of the second subset of bit fields having the first value, or both.

12. The UE of claim 11, wherein a second codepoint of the set of codepoints indicates the one or more downlink TCI states from the first set of TCI states in accordance with the corresponding bit field of the first subset of bit fields having the first value and in accordance with the corresponding bit field of the second subset of bit fields having a second value different from the first value.

13. The UE of claim 6, wherein:
a first subset of bit fields of the second set of bit fields corresponds to uplink TCI states of the first set of TCI states,
a second subset of bit fields of the second set of bit fields corresponds to uplink TCI states of the second set of TCI states, and
a first codepoint of the set of codepoints indicates one or more of the uplink TCI states from the first set of TCI states, one or more uplink TCI states from the second set of TCI states, or both in accordance with a corresponding bit field of the first subset of bit fields having a first value and in accordance with a corresponding bit field of the second subset of bit fields having the first value.

14. The UE of claim 13, wherein a second codepoint of the set of codepoints indicates the one or more uplink TCI states from the first set of TCI states in accordance with the corresponding bit field of the first subset of bit fields having the first value and in accordance with the corresponding bit field of the second subset of bit fields having a second value different from the first value.

15. A user equipment (UE), comprising:
a processing system that includes processor circuitry and memory circuitry that stores code, the processing system configured to cause the UE to:
receive control signaling indicating a first set of transmission configuration indicator (TCI) states configured for a first transmission reception point (TRP) and a second set of TCI states configured for a second TRP, wherein the UE performs downlink communications with the first TRP, and wherein the UE performs uplink communications with the second TRP;
receive a first medium access control-control element (MAC-CE) that activates a first set of codepoints that correspond to the first set of TCI states in accordance with a first bit of the MAC-CE having a first value;
receive a second MAC-CE that activates a second set of codepoints that correspond to the second set of TCI states in accordance with a first bit of the second MAC-CE having a second value that is different from the first value;
communicate with the first TRP using one or more first TCI states of the first set of TCI states in accordance with the first MAC-CE; and
communicate with the second TRP using one or more second TCI states of the second set of TCI states in accordance with the second MAC-CE.

16. The UE of claim 15, wherein the processing system is further configured to cause the UE to:
receive downlink control information (DCI) that indicates a first codepoint of the first set of codepoints in accordance with a first bit of the DCI having the first bit value, wherein the first codepoint indicates the one or more first TCI states.

17. The UE of claim 15, wherein the processing system is further configured to cause the UE to:
receive downlink control information (DCI) that indicates a first codepoint of the second set of codepoints in accordance with a first bit of the DCI having the second bit value, wherein the first codepoint indicates the one or more second TCI states.

18. The UE of claim 15, wherein:
the first MAC-CE comprises a set of bit fields,
each bit field of the set of bit fields corresponds to a respective codepoint of the first set of codepoints,
a first value of a first bit field of the set of bit fields indicates that a corresponding codepoint of the first set of codepoints indicates an uplink TCI state and a downlink TCI state, and
a second value of the first bit field indicates that the corresponding codepoint indicates a downlink TCI state, a joint TCI state, or an uplink TCI state.

19. The UE of claim 15, wherein:
the second MAC-CE comprises a set of bit fields,
each bit field of the set of bit fields corresponds to a respective codepoint of the second set of codepoints,
a first value of a first bit field of the set of bit fields indicates that a corresponding codepoint of the second set of codepoints indicates an uplink TCI state and a downlink TCI state, and
a second value of the first bit field indicates that the corresponding codepoint indicates a downlink TCI state, a joint TCI state, or an uplink TCI state.

20. A method for wireless communications at a user equipment (UE), comprising:
receiving control signaling indicating a first set of transmission configuration indicator (TCI) states configured for a first transmission reception point (TRP) and a second set of TCI states configured for a second TRP, wherein the UE performs downlink communications with the first TRP, and wherein the UE performs uplink communications with the second TRP;
receiving a medium access control-control element (MAC-CE) that activates one or more first TCI states of the first set of TCI states and activates one or more second TCI states of the second set of TCI states;
communicating with the first TRP using at least one TCI state of the one or more first TCI states in accordance with the MAC-CE; and
communicating with the second TRP using at least one TCI state of the one or more second TCI states based at least in part on the MAC-CE.
